(19) United States
(12) Patent Application Publication
(10) Pub. No.: US 2026/0140021 A1
(43) Pub. Date: May 21, 2026

(54) Automated Systems For Processing Seeds, And Relates Methods

(71) Applicant: Monsanto Technology LLC, Saint Louis, MO (US)

(72) Inventors: Jacob BERGFELD, Ankeny, IA (US); Shishir GUPTA, Ankeny, IA (US); Andrew MADDUX, Ankeny, IA (US); Dustin SMITH, Ankeny, IA (US)

(21) Appl. No.: 19/119,365

(22) PCT Filed: Oct. 9, 2023
(86) PCT No.: PCT/US2023/034762

§ 371 Date: Apr. 8, 2025

Related U.S. Application Data
(60) Provisional application No. 63/414,706, filed on Oct. 10, 2022.

(51) Int. Cl. G01N 1/04; A01C 1/00; G01N 35/04

(52) U.S. Cl. CPC G01N 1/04; A01C 1/00; G01N 35/04

(57) ABSTRACT

An automated system for sampling and/or sorting seeds is provided. In one example, the system includes a sampling module operable to remove tissue from a seed and deposit the seed from which the tissue is removed in a seed tray. The system also includes a docking station configured to hold the seed tray apart from the sampling module, and a transfer unit configured to selectively transfer the seed tray between the sampling module and the docking station. The docking station may include a cart configured to hold one or more seed trays, one or more sample plates, and/or one or more attachments for the transfer unit configured for holding the seed trays and/or the sample plates.

### CROSS-REFERENCE TO RELATED APPLICATION

This application claims the benefit of, and priority to, U.S. Provisional Application Ser. No. 63/414,706, filed on Oct. 10, 2022. The entire disclosure of the above application is incorporated herein by reference.

### FIELD

The present disclosure generally relates to automated systems and methods for processing seeds. More particularly, the present disclosure relates to automated systems and methods for removing tissue samples from seeds (broadly, for removing samples from biological materials), for collecting the tissue samples removed from the seeds, and/or for sorting seeds (e.g., the seeds from which the tissue samples are removed, other seeds, etc.).

### BACKGROUND

This section provides background information related to the present disclosure which is not necessarily prior art.

In plant development, genetic improvements are made in the plant, either through selective breeding or genetic manipulation, and when a desirable improvement is achieved, a commercial quantity is developed, or bulked, by planting and harvesting seeds over several generations. However, not all harvested seeds express the desired traits and, thus, these seeds need to be culled from the bulked quantity. To hasten the process of bulking up the quantity of seeds, statistical samples may be taken and tested to cull seeds (or groups of seeds associated with the statistical samples), from the original quantity of seeds, that do not adequately express the desired trait.

Additionally, sorting small agricultural, manufactured and/or produced objects such as seeds can be cumbersome. For example, in seed breeding, large numbers of seeds are sampled and analyzed to determine whether the seeds possess a particular genotype or trait of interest. This may include imaging the seeds to obtain samples for analysis. Or, this may include removing tissue from the seeds for analysis. In the latter, portions of each seed may be removed, while leaving the remaining seed viable for planting. The removed portions, or chips, and the corresponding seeds are then cataloged to track the seeds and the respective corresponding chips. In both cases, the resulting chip may be analyzed to identify various attributes of the respective chip and seed, such as DNA characteristics and/or traits. Thereafter, the seeds are individually sorted according to attributes of each respective seed, based on the analysis of the chip removed therefrom.

### SUMMARY

This section provides a general summary of the disclosure, and is not a comprehensive disclosure of its full scope or all of its features.

Example embodiments of the present disclosure generally relate to automated systems for sampling and/or sorting seeds. In one example embodiment, an automated system of the present disclosure generally includes a sampling module operable to remove tissue from a seed and deposit the seed from which the tissue is removed in a seed tray; a docking station configured to hold the seed tray apart from the sampling module; and a transfer unit configured to selectively transfer the seed tray between the sampling module and the docking station.

Example embodiments of the present disclosure also generally relate to automated seed sampling modules for removing tissue from seeds. In one example embodiment, an automated seed sampling module of the present disclosure generally includes a seed plate configured to singulate a seed from multiple seeds, the seed plate including multiple apertures each configured to hold a seed on the seed plate, at least one of the multiple apertures including a different size than another one of the multiple apertures; and a sampling assembly operable to remove tissue from the singulated seed.

Example embodiments of the present disclosure also generally relate to automated methods for processing seeds. In one example embodiment, an automated method of the present disclosure generally includes singulating a seed from a plurality of seeds at a sampling module; removing tissue from the singulated seed at the sampling module; after removing tissue from the singulated seed, receiving the singulated seed in a well of a seed tray; moving, by an automated transfer unit, the seed tray from the sampling module to a docking station; returning, by the automated transfer unit, the seed tray from the docking station to the sampling module; removing, by a seed deposit unit, the singulated seed from the well of the seed tray; and delivering, by the seed deposit unit, the singulated seed to another well of the seed tray or to another seed tray.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example seed sampling and sorting system including one or more aspects of the present disclosure;

FIG. 2 is a perspective view of an example seed sampling module of the system of FIG. 1;

FIG. 3 is a top view of the seed sampling module of FIG. 2;

FIG. 4 is a side view of the seed sampling module of FIG. 2;

FIG. 5 is another perspective view of the seed sampling module of FIG. 2, with a casing of the module shown as transparent to illustrate internal components of the module;

FIG. 6 is a section view of a hopper and a separating wheel (or singulating module) of the seed sampling module of FIG. 2;

FIG. 7 is a perspective view of the hopper and the separating wheel of FIG. 6;

FIGS. 8A-8C are perspective views of an elevator unit of the seed sampling module of FIG. 2;

FIG. 9 is a perspective view of a seed transport unit and a seed imaging assembly of the seed sampling module of FIG. 2;

FIG. 10 is a section view of the seed transport unit and the seed imaging assembly of FIG. 9;

FIG. 11 is a perspective view of a seed sampling assembly of the seed sampling module of FIG. 2;

FIG. 12 is a section view of the seed sampling assembly of FIG. 11;

FIG. 13 is a perspective view of a sample collection assembly (e.g., including a seed and chunk gantry module used for sample collection, etc.) and a seed collection assembly of the seed sampling module of FIG. 2;

FIG. 14 is another perspective view of the sample collection assembly (e.g., including a seed and chunk gantry module used for sample collection, etc.) and the seed collection assembly of the seed sampling module of FIG. 2, including a seed collector unit coupled to the sample collection assembly;

FIG. 15 is another perspective view of the sample collection assembly (e.g., including a seed and chunk gantry module used for sample collection, etc.) and the seed collection assembly of the seed sampling module of FIG. 2, illustrating a seed deposit unit (e.g., an offload module, etc.) coupled to the sample collection assembly;

FIG. 16A is a perspective view of an end portion of the seed deposit unit (e.g., for seed sorting and seed deposit within the seed sampling module, etc.) of FIG. 15;

FIG. 16B includes side views of the seed deposit unit of FIG. 16A illustrating operation;

FIG. 17 is a perspective view of a docking station (e.g., for seed storage trays, etc.) of the seed sampling and sorting system of FIG. 1;

FIG. 18 is a perspective view of a transfer unit of the seed sampling and sorting system of FIG. 1;

FIG. 19 is a block diagram of an example relationship between the seed sampling and sorting system of FIG. 1 and a control system suitable or use therewith;

FIG. 20 is a block diagram of a computing device that may be used in the example arrangement of FIG. 19;

FIG. 21 is a perspective view of the seed sampling and sorting system of FIG. 1 and including multiple docking stations;

FIG. 22 is a perspective view of an example docking station configured to hold sample plates and other materials for use in the seed sampling and sorting system of FIG. 1;

FIG. 23 is a perspective view of an example docking station configured to hold robotic attachments for use in the seed sampling and sorting system of FIG. 1;

FIG. 24 is a perspective view of an example docking station configured to hold sample plates for use in the seed sampling and sorting system of FIG. 1;

FIGS. 25-26 are perspective views of an example robot configured for use with the docking stations of the seed sampling and sorting system of FIG. 1; and

FIG. 27 is a perspective view of an example docking station configured to hold seed trays for use in the seed sampling and sorting system of FIG. 1.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

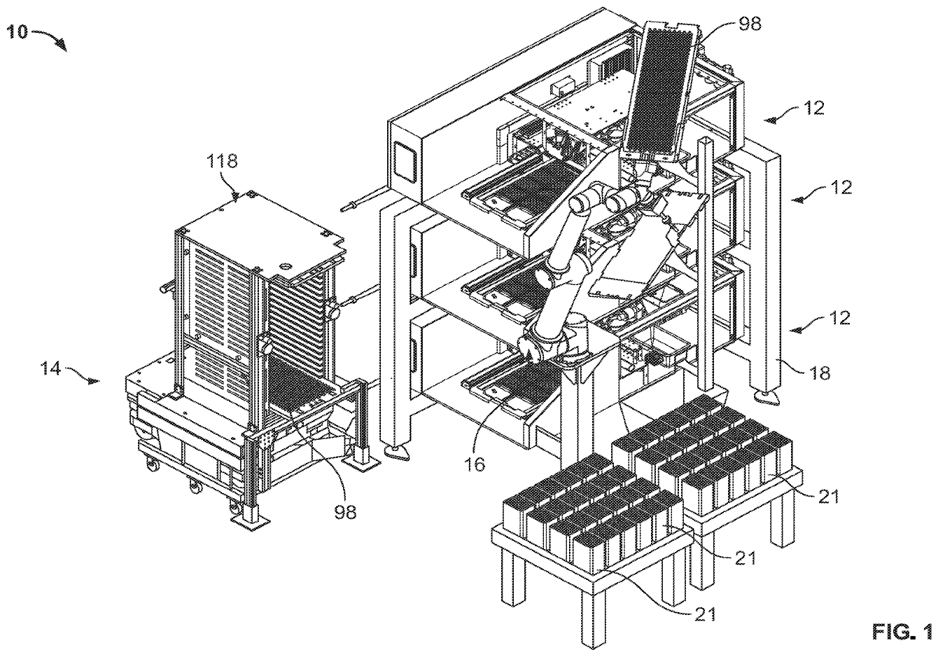

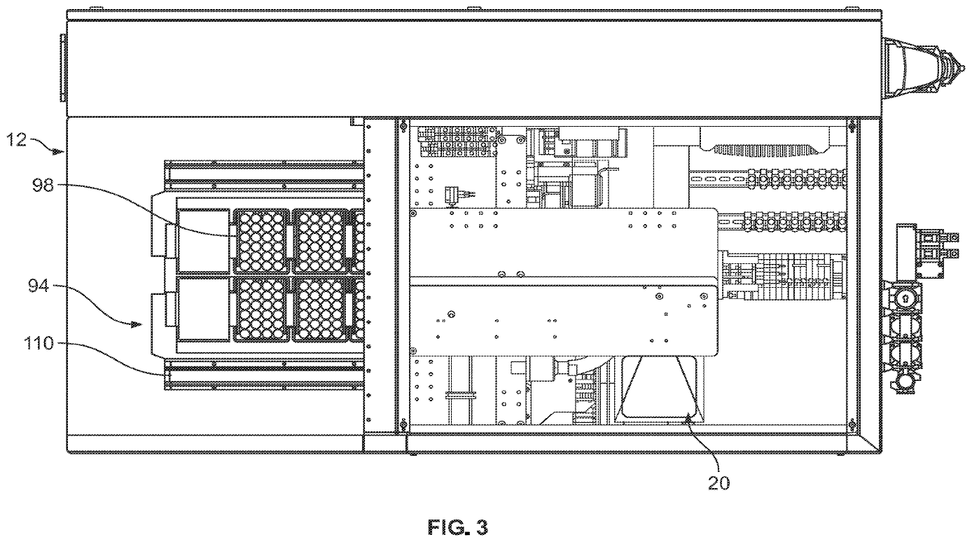

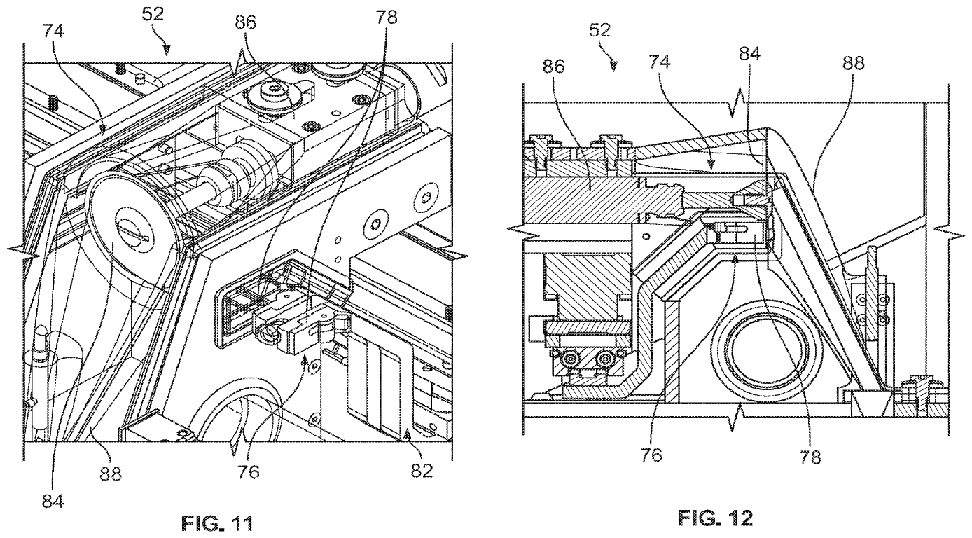

FIGS. 1-18 illustrate an example embodiment of an automated seed sampling and sorting system 10 including one or more aspects of the present disclosure. In one aspect, the illustrated system 10 is suitable for use in removing samples from biological materials (e.g., sampling the materials, chipping the materials, etc.), and collecting the samples (e.g., in one or more receptacles, etc.) and/or collecting the biological materials from which the samples were removed (e.g., in one or more receptacles, etc.). In connection therewith, the samples removed from the biological materials may include, for example, tissue, tissue samples, tissue pieces, tissue chunks, etc. And, biological materials may include, for example, seeds, etc. In another aspect, the illustrated system 10 is suitable for use in automatically (e.g., robotically, etc.) sorting biological materials (e.g., between receptacles, etc.) and depositing the sorted materials into selected receptacles based on particular attributes of the sorted materials (e.g., characteristics and/or traits such as size, shape, color, composition, quality, weight, genetic traits, etc. as determined by analysis of the corresponding samples; etc.) (e.g., independent of removing samples from the biological materials, as part of removing samples from the biological materials, etc.).

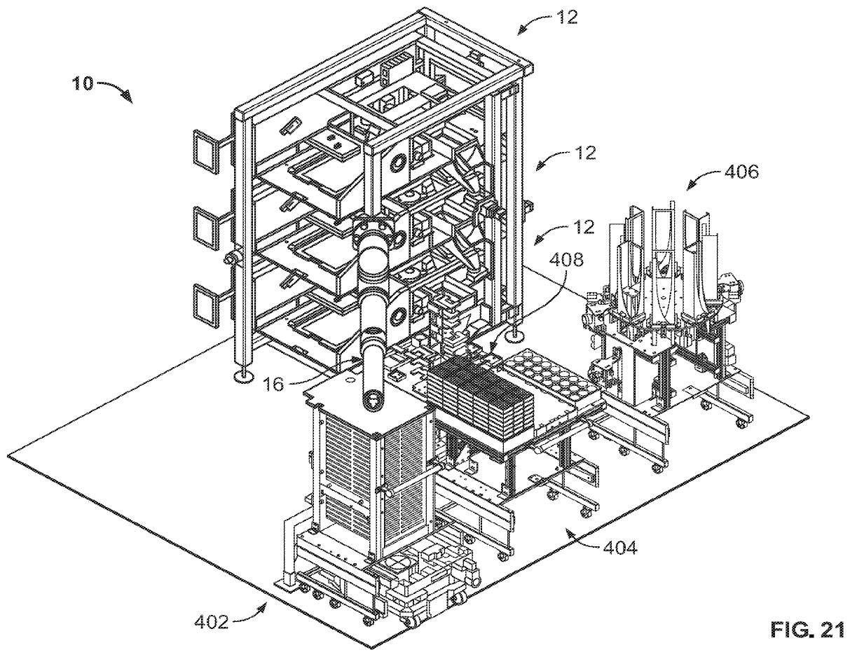

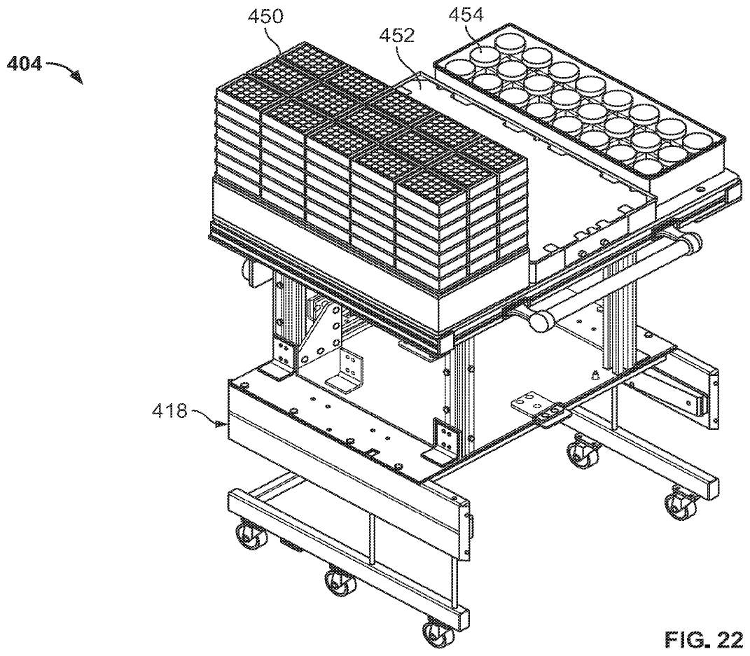

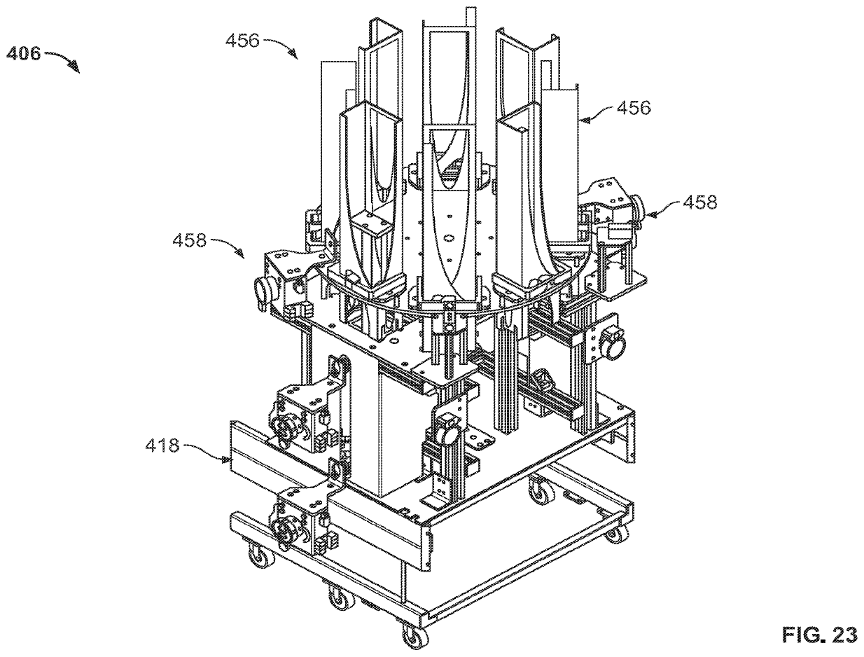

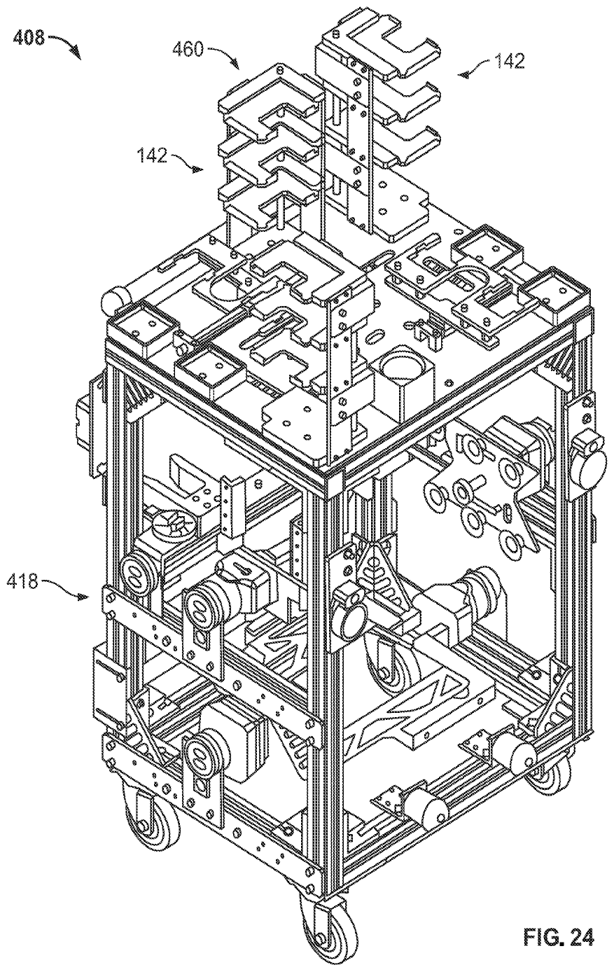

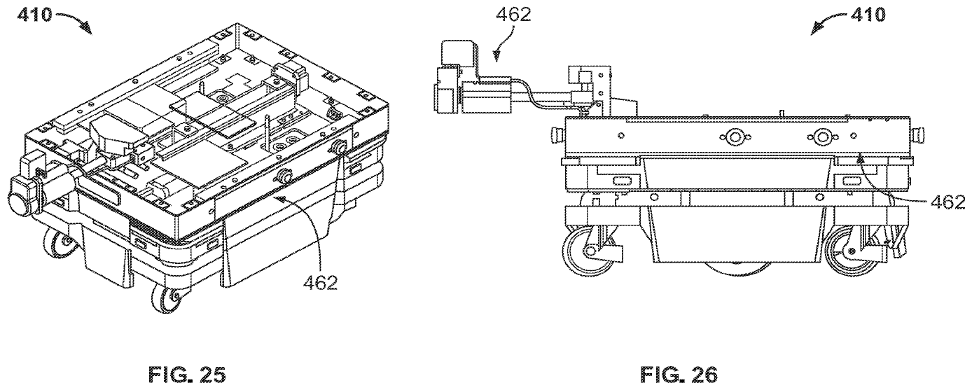

As shown in FIG. 1, the illustrated system 10 generally includes multiple seed sampling modules 12, a docking station 14, and a transfer unit 16. The sampling modules 12 are arranged in a generally stacked (or vertical or modular) configuration on frame 18 (e.g., with one of the modules 12 positioned generally above another one of the modules, etc.). And, the transfer unit 16 is then disposed on the frame adjacent the sampling modules 12. In this arrangement, the transfer unit 16 is operable to access both the docking station 14 and the sampling modules 12, as will be described in more detail hereinafter, to transfer trays therebetween (e.g., seed trays, sample plates, etc.). While three seed sampling modules 12 are illustrated in FIG. 1, it should be appreciated that the system 10 may include more than three seed sampling modules or fewer than three seed sampling modules in other embodiments. For instance, in one example embodiment, the system 10 may include a single sampling module 12. In addition, while one docking station 14 is illustrated in FIG. 1, it should be appreciated that the system 10 may include more than one docking station in other embodiments. For instance, as described hereinafter with reference to FIGS. 21-27, the system 10 may include multiple docking stations having different configurations for use in the system 10 (e.g., for conveying seed trays and/or sample plates to/from the system 10, for conveying tools to the system 10, etc.).

The sampling modules 12 of the system 10 are each configured to receive seeds, singulate the seeds, and remove tissue (e.g., tissue chunks, etc.) from each of the singulated seeds (e.g., as a single seed input/flow, etc.). The tissue, along with the seeds from which the tissue is removed, may be collected so that a relationship is maintained therebetween (e.g., a one-to-one relationship so that the seeds can be subsequently identified based on the tissue removed therefrom, etc.). The collected seeds are then removed from the sampling modules 12, via the transfer unit 16, and positioned in the docking station 14 for subsequent use. In turn, the tissue removed from the collected seeds may also be removed from the sampling modules 12 (e.g., via the transfer unit 16, etc.) and analyzed to determine if the corresponding seeds, from which the tissue was taken, exhibit or do not exhibit one or more desired traits. And, based on the analysis, the corresponding seeds from which the tissue was removed can be subsequently identified (e.g., from the docking station 14, etc.) and used as desired (e.g., sorted via the system 10 to other containers, etc.). That said, it should be appreciated that in some examples, the seeds from which the tissue is removed may not be collected, and instead may be discarded.

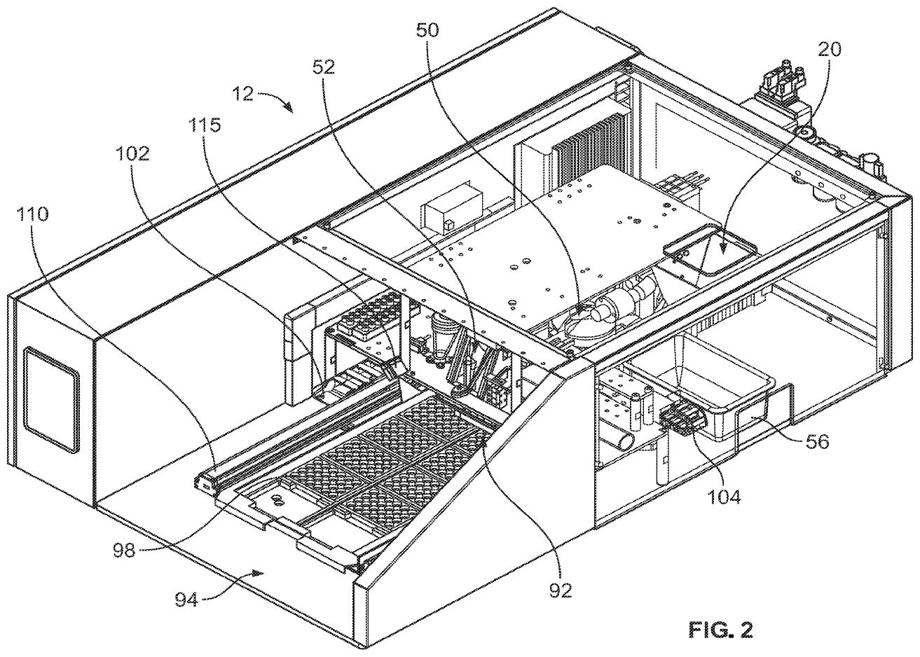

FIGS. 2-5 illustrate an example one of the seed sampling modules 12 of the system 10. That said, each of the seed sampling modules 12 is substantially the same. As such, it should be appreciated that the following description applies to each of the illustrated modules 12.

The seed sampling module 12 generally includes a hopper 20 for receiving seeds into the module 12, for sampling (e.g., a bulk quantity of seeds, etc.). The seeds may be provided to and/or received in the hopper 20 in any desired manner (manually, automatically, etc.). For instance, the seeds may be provided to the hopper by a user or by an automated robot, for example, from seed packets 21 (see, e.g., FIG. 1, etc.), or other seed containment devices (e.g., tubes, cells, cassettes, cylinders, plates, etc.), where the seed packets 21 (or other containment devices) can include any desired types and/or quantities of seeds, for example, as described herein.

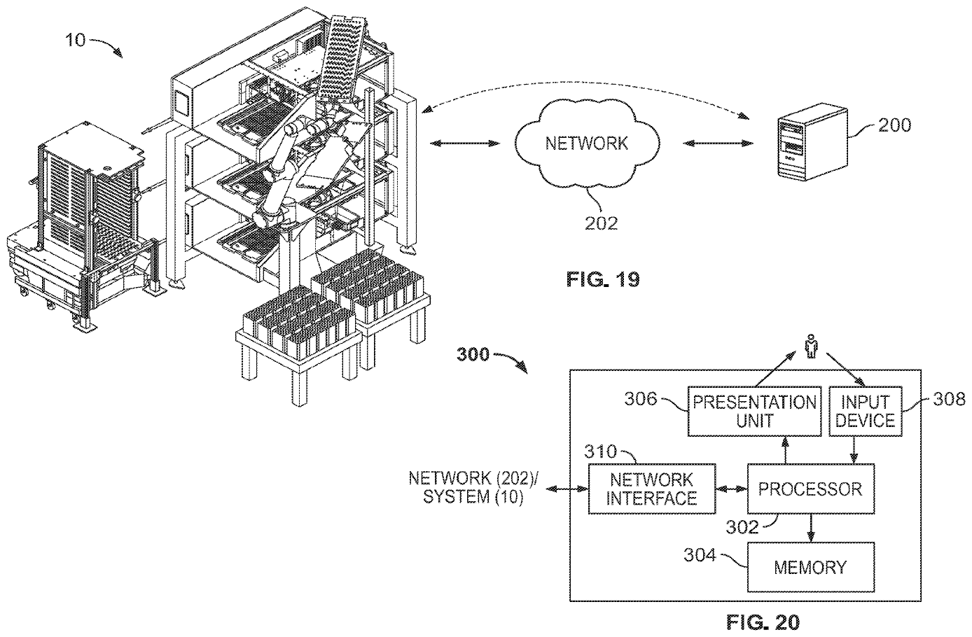

The seed packets 21 may represent different projects, or groupings of seeds, desired to be analyzed for one or more reasons (e.g., for one or more of the reasons described herein, etc.). Each seed packet 21 generally includes an indicia associated therewith (e.g., a barcode, a QR code, an RFID tag, a magnetic tag, a magnetic strip, an alphabetic and/or numeric indicia, another indicia, etc.). The indicia, then, can be used to identify logistic data regarding the respective seed packet 21 (and the seeds included therein). Such logistic data may be generated based on specific genotypes or attributes of each particular seed in the seed packet 21 and may include, for example, characteristics and/or traits such as type, size, shape, color, composition, quality, weight, genetic traits, etc. of the seeds therein. In addition, the logistic data may include data indicating whether or not the seeds in the seed packet 21 are to be analyzed and, for seeds that are to be analyzed, the particular analysis to be performed and the particular sampling requirements for the seeds and/or their required analysis (e.g., including a number of tissue samples to be taken from the seeds, etc.). The logistic data may then be used, by a central control system (see, e.g., control system 200 of FIG. 19, etc.) (or directly by the system 10) to set, direct, update, modify, etc. the various components of the system 10 as described herein so that appropriate tissue chunks, samples, etc. are removed from the given seeds and so that appropriate analysis of the tissue may be performed (particularly, for example, where the system 10 is integrated with one or more analysis units configured to perform the different analyses described herein). With that said, such logistic data may relate to (without limitation) the types of seeds in the seed packet 21, sample sizes for such seeds, an analysis to be performed, a number of samples required for such analysis, etc. The logistic data can be compiled in any suitable or desirable format, for example, the logistic data can be compiled into one or more electronic data structures, databases, spreadsheets and/or look-up tables, etc. that are then accessible to the seed sampling system 10 (e.g., via a suitable network, etc.) and/or users thereof.

As an example, to initiate operation of the system 10, the indicia from a given seed packet 21 may be input to the control system 200 (e.g., via a user interface, via communication with a reader/input device, etc.), for instance, which is in communication with the system 10 via a network, etc. In turn, a processor associated with the control system 200 may access the logistic data associated with the seed packet 21 in a logistics data structure (e.g., in a data structure in memory associated with the processor of the control system 200, in a remote data structure accessible by the processor of the control system 200 via a network, etc.). Then, based on the logistic data, the processor may control operation of the system 10 as described in detail below (even though the processor may not be expressly referenced), to setup custom processing conditions (e.g., seed singulation, air pressures, vacuum pressures, component positions, timings, tissue removal parameters, etc.) to singulate the seeds in the given seed packet 21 and remove desired tissue samples therefrom, etc. In various embodiments, the indicia associated with the seed packets 21 may be automatically read, or interpreted, by a user interface and automatically input to the control system 200. In one instance, the indicia may include a barcode and the user interface may include a suitable barcode reader.

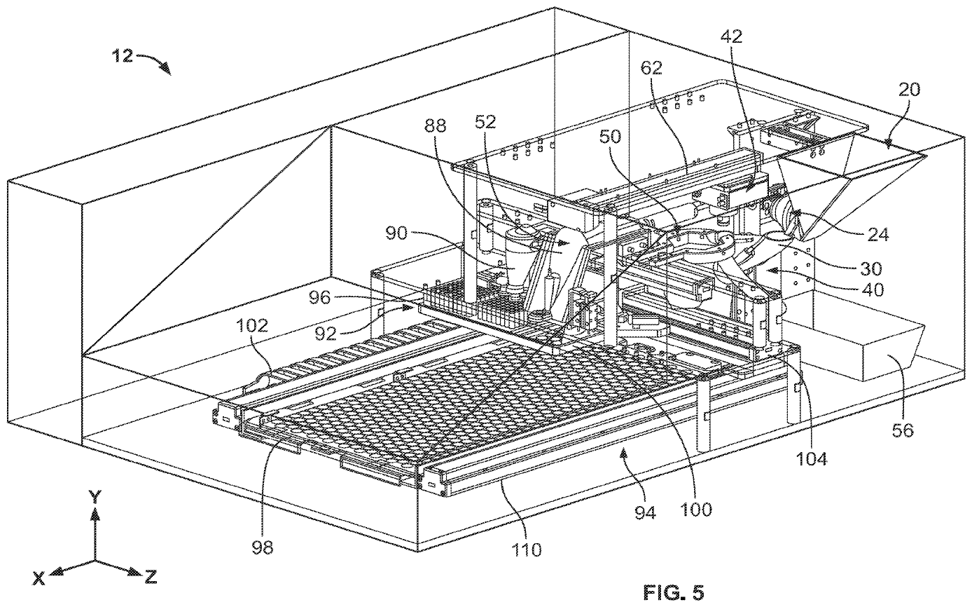

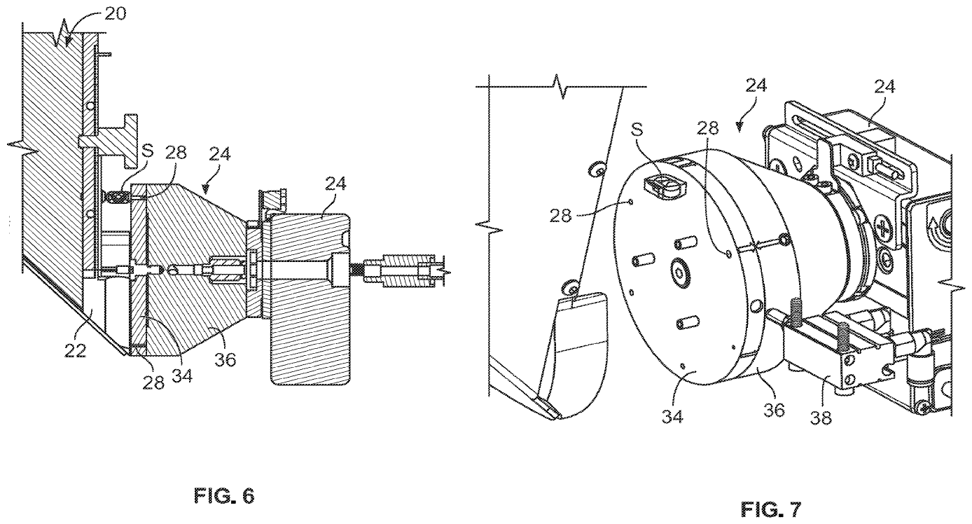

With additional reference to FIGS. 6 and 7, the hopper 20 defines, includes, etc. a reservoir 22 for holding the received seeds therein (e.g., from the seed packets 21, etc.). A separating wheel 24 (broadly, a singulation unit or seed plate or seed meter) is disposed at least partially in communication with the reservoir 22 (and particularly in communication with seeds in the reservoir 22). The separating wheel 24 is configured to rotate (via motor 26) relative to the hopper 20. Apertures 28 (or openings) of the separating wheel 24 (in conjunction with a vacuum source) are configured to capture individual seeds from the grouping of seeds in the hopper 20 and retain the seeds in (or against) the apertures 28 as desired (via desired vacuum pressure, for example, based on the particular seeds received into the hopper 20, etc.). As the separating wheel 24 rotates, it moves the apertures 28 generally through the reservoir 22. Suction is supplied to the apertures 28 so that the apertures 28 passing through and/or adjacent to the reservoir 22 capture and hold individual seeds within/against the apertures 28 (e.g., seed S in FIGS. 6 and 7, etc.). As the separating wheel 24 continues to rotate, it moves the apertures 28 and captured seeds out of, and generally away from, the reservoir 22 and to a release location. At the release location, the captured seeds are dislodged from the apertures (via reduced suction within the apertures and/or via wipers (not shown)) and received (e.g., via gravity, vacuum pressure, etc.) in a transport channel 30 (FIG. 5) (e.g., a pilot tube, etc.). The separating wheel 24 then continues to rotate, and eventually moves the emptied apertures 28 back to the reservoir 22 to capture additional seeds from the hopper 20, as appropriate, for example, until all seeds from the hopper 20 are transferred to the transport channel 30, or until a desired number of seeds from the hopper 20 are transferred to the transport channel 30, etc.

In the illustrated embodiment, the separating wheel 24 includes multiple apertures 28 having different sizes (e.g., different diameters, etc.). In this manner, the separating wheel 24 is configured to accommodate seeds having different sizes and/or shapes, and/or different types of seeds (e.g., the same separating wheel 24 may be used with different types and/or sizes of seeds, etc.). For instance, the separating wheel 24 may include one or more apertures 28 with diameters of about 0.5 mm, one or more apertures 28 with diameters of about 0.75 mm, one or more apertures 28 with diameters of about 1.0 mm, one or more apertures 28 with diameters of about 1.25 mm, one or more apertures 28 with diameters of about 1.5 mm, one or more apertures 28 with diameters of about 1.75 mm, one or more apertures 28 with diameters of about 2.0 mm, one or more apertures 28 with diameters of about 2.25 mm, one or more apertures 28 with diameters of about 2.5 mm, one or more apertures 28 with diameters smaller than about 0.5 mm, one or more apertures 28 with diameters greater than about 2.5 mm etc.

In connection with the above, the illustrated separating wheel 24 includes a face 34 that may be selectively rotated relative to a body 36 (e.g., via interaction of actuator 38 with the face 34, etc.) to align select ones of the apertures 28 with the vacuum source (within the body 36 of the separating wheel 24) and at the same time blocking other ones of the apertures 28 from the vacuum source, so that only the select ones of the apertures 28 aligned with the vacuum source operate to singulate seeds from the hopper 20. In this way, the separating wheel 24 may be adjusted to accommodate the particular seeds being provided to the system 10 for sampling (e.g., based on the given logistic data for the seeds being provided to the system 10, etc.). Such adjustment may be performed manually, or it may be automated via the control system 200. For instance, the control system 200 may receive an input of a particular seed type being provided to the seed sampling module 12 (via a user interface, etc.) (e.g., corn, soy, cotton, watermelon, melon, wheat, rice, another type as described herein, etc.) and then instruct the actuator 38 to engage the face 34 of the separating wheel 24 and align the appropriate one or more of the apertures 28 with the vacuum source, etc.

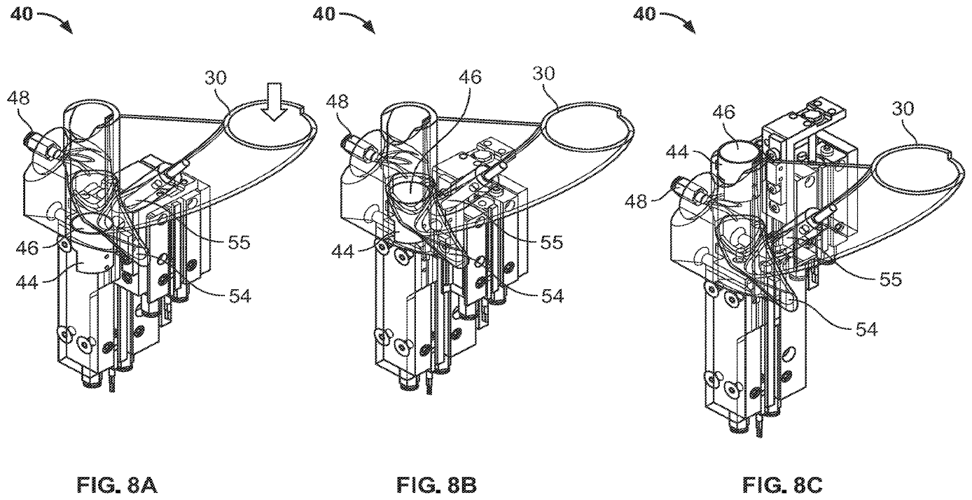

With reference now to FIGS. 5 and 8A-8C, the seed sampling module 12 includes an elevator unit 40 configured to receive a singulated seed from the transport channel 30 (e.g., via gravity, induced air flow, etc.) for subsequent transfer to seed sampling assembly 52 (via a seed transport assembly 42). In connection therewith, the transport channel 30 may include a gate so that the singulated seeds received from the hopper 20 (via the separating wheel 24) are transferred, by the transport channel 30, to the elevator unit 40 when the elevator unit 40 is empty and ready to receive the seed (e.g., when a prior seed at the elevator unit 40 has already been passed to the seed transport assembly 42, etc.).

In the example embodiment, the elevator unit 40 includes a piston 44 moveable (e.g., via pneumatic operation, etc.) between a retracted (or lowered) position (FIG. 8A) and an elevated position (generally above the retracted position) (FIG. 8C). When in the retracted position (FIG. 8A), the piston 44 can receive a seed from the transport channel 30 onto an end portion 46 of the piston 44 (via an inlet in communication with the transport channel 30 and a corresponding channel leading through the elevator unit 40 from the inlet to the piston 44). The piston 44 is then configured to elevate the seed generally above the elevator unit 40 (to an elevated position (FIG. 8C)) and present the seed for transfer/hand-off to the seed transport assembly 42 (for subsequent transport to seed imaging assembly 50 and seed sampling assembly 52). In various embodiments, the end portion 46 of the piston 44 may include a suction cup (e.g., a vacuum cup, etc.) for use in receiving and retaining the seed (e.g., via negative pressure suction applied thereto, for example, through the piston 44, etc.).

Also in the example elevator unit 40, the piston 44 can be actuated to a position (FIG. 8B) in which the end portion 46 of the piston 44 is exposed to an outlet 54. The piston 44 may be actuated to this position, for example, to expel a seed through the outlet 54 (e.g., via gravity, via compressed air source 48, via vacuum pressure, etc.) from the elevator unit 40 to a remnant bin 56 (or another location, etc.) if hand-offs are missed to the seed transport assembly 42, or if multiple seeds are detected in the elevator unit 40 at a given time, or if a seed is detected (via a sensor at the elevator unit 40, for example) having one or more specific characteristics (e.g., undesirable characteristics, particular sizes, particular types, etc. based on intermediate analysis, etc.), etc. For instance, in the illustrated embodiment the elevator unit 40 includes an imaging device 55 (e.g., a camera, etc.) configured to capture image data of the seed as the seed is received on the end portion 46 of the piston 44. In doing so, the imaging device 55 (alone or via communication with the control system 200) is configured to determine presence of the seed on the end portion 46 of the piston 44, whether the seed is a single seed or whether multiple seeds are present on the end portion 46, and/or one or more other characteristics of the seed. In turn, based on the image data, the piston 44 is configured to actuate (e.g., via the control system 200, etc.) to either the outlet 54 (FIG. 8B) to discharge the seed(s) to the remnant bin 56 (e.g., if the image data indicates that multiple seeds are present on the end portion 46 of the piston 44, etc.) or to the elevated position (FIG. 8C) for transfer of the seed to the seed transport assembly 42 (e.g., if the image data indicates that a single seed is present on the end portion 46 of the piston 44, etc.).

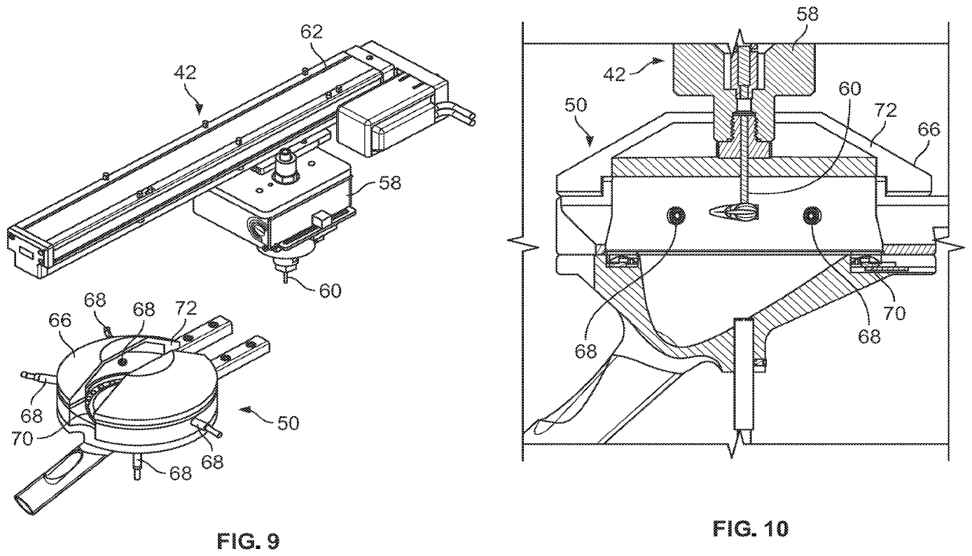

As shown in FIGS. 5 and 9, the seed transport assembly 42 of the system 10 generally includes a transport carrier 58 and a retention member 60 supported by the transport carrier 58. The illustrated transport carrier 58 is coupled to a guide 62, whereby the transport carrier 58 is moveable (e.g., slidable via an actuator, via a motor drive unit, etc.) in a generally linear direction along the guide 62 (e.g., in an X-direction of the sampling module 12 as shown in FIG. 5, etc.). As described, the transport carrier 58 is configured to move the singulated seed (in the X-direction of the sampling module 12, etc.) from the elevator unit 40, through the imaging assembly 50 (also see FIG. 10), and then to the sampling assembly 52.

The retention member 60 of the seed transport assembly 42 is extendable from the transport carrier 58 (e.g., via pistons, etc.) and is configured to move angularly, as desired. This allows the retention member 60 to move as needed to retrieve (and capture) a seed from the elevator unit 40 (e.g., even when the elevated seed is not immediately vertically aligned with the retention member 60, etc.). What's more, the retention member 60 is also configured to rotate so that, once the seed is retrieved from the elevator unit 40, the retention member 60 can operate to orient the seed in a desired orientation, position, etc. In connection therewith, the retention member 60 includes an end portion configured to retain, hold, etc. the seed received from the elevator unit 40. In the illustrated embodiment, the end portion of the retention member 60 includes a suction tip (e.g., a vacuum cup, a vacuum needle, etc.) for use in receiving and retaining the seed (e.g., via negative pressure suction, etc.). The suction tip is configured such that when negative air pressure is supplied to the suction tip (via suitable means), the seed can be engaged and retained thereby. In other example embodiments, seed sampling systems may include seed transport assemblies having retention members with end portions defining other than suction tips for use in receiving and retaining seeds, for example, mechanical holders, seed gripping mechanisms, etc.

In operation of the seed transport assembly 42 (when the elevator unit 40 moves a seed to the elevated position), the transport carrier 58 is configured to position the retention member 60 generally over the elevator unit 40. In turn, the retention member 60 (specifically, the end portion of the retention member 60) is configured to engage and receive the seed from the elevator unit 40. As described above, this may involve actuating the retention member 60 as necessary to allow the end portion thereof to properly engage the seed (e.g., extending the retention member 60 relative to the transport carrier 58 toward the seed, moving the retention member 60 angularly relative to the transport carrier 58, etc.), and/or this may involve actuating the piston 44 of the elevator unit 40 as necessary to allow the end portion of the retention member 60 to properly engage the seed (e.g., extending and/or otherwise moving the piston 44 of the elevator unit 40 toward the retention member 60, etc.). And, once the seed is engaged (and captured), the transport carrier 58 is configured to move the seed to the seed imaging assembly 50, as described next.

With additional reference to FIG. 10, the seed imaging assembly 50 is positioned generally between the elevator unit 40 and the sampling assembly 52. In this position, the elevator unit 40, the imaging assembly 50, and the sampler are generally aligned below the guide 62 such that the seed transport assembly 42 is able to move a seed from the elevator unit 40, to the imaging assembly 50, and to the sampling assembly 52 (e.g. generally linearly in the X-direction of the sampling module 12, etc.).

The seed imaging assembly 50 includes a housing 66 and multiple cameras 68 positioned within the housing 66. The cameras 68 are configured to capture images of the types described herein (and/or suited for the particular imaging application of the system 10). In addition, the imaging assembly 50 also includes a light source 70 disposed for illuminating a field of view of the cameras 68 (e.g., within the housing 66, etc.) as needed. The light source 70 may include any type of light source suited for the particular imaging application of the system 10 (e.g., incandescent lights, fluorescent lights, ultraviolet lights, infrared (IR) lights, light emitting diodes (LEDs), etc.). With that said, the illustrated imaging assembly 50 includes four cameras 68, each configured to image a seed within the housing 66 at a different angle (e.g., from different sides of the seed, from a bottom of the seed, etc.). It should be appreciated, however, that the system 10 may include other numbers of cameras in other embodiments (e.g., more than four, less than four, etc.).

The seed imaging assembly 50 is structured and operable to image the seed captured by the seed transport assembly 42 when positioned within the housing 66 of the assembly 50. In particular, the seed imaging assembly 50 is configured to collect multiple images of the seed as the seed is held in the retention member 60 of the seed transport assembly 42 (as the seed transport assembly 42 moves the seed into and/or through the seed imaging assembly 50). The images collected of the seed can be any desired type(s) of images. For example, the images may be a visual images (color and/or black and white), IR images (associated with the IR band) (e.g., to “see” haploid seeds, etc.), NIR images or NMR/MRI images, or any other type of images or related spectral data. What's more, the images may include a two-dimensional images (through which two-dimensional (2-D) seed metrics of the seed may then be gathered, including (without limitation) cap/tip location, seed area, seed shape, disease, etc.), or the images may include three-dimensional (3-D) images derived with from multiple 2-D images, or leveraging a laser profiler, or any combination of techniques to derive a 3-D measurement.

Once the images are collected by the imaging assembly 50, they are communicated to the control system 200 for storage in an associated data structure and processing as described herein. For example, the images may be used to determine orientations of the seed at the retention member 60, and to direct operation of the retention member 60 to rotate and orient the seed in a desired position prior to sampling operation. In connection therewith, for instance, the images may be used to locate an embryo of the seed so that the seed can be oriented (by the retention member 60) in a desired position whereby when the seed is delivered to the sampling assembly 52, tissue can be removed from the seed without damaging the embryo. Also for example, the images may be used to help analyze the seed in connection with any tissue analysis performed on the tissue removed from the seed when sampling operation is performed, for example, for use in single-seed phenotyping (e.g., to determine seed volume and/or seed shape, to identify disease, to identify non-viable seed material, etc.) and/or as part of directing operation of the seed sampling assembly in removing tissue from the seed. Further, the images may be used to direct sampling operation of the sampling assembly 52, for example, to facilitate removal of a particular amount and/or size of tissue from the seed (e.g., about 5 mg or less, at least about 5 mg, between about 5 mg and about 20 mg, between about 5 mg and about 10 mg, etc.).

In operation of the imaging assembly 50, the transport carrier 58 of the seed transport assembly 42 is configured to move the captured seed (via the retention member 60) from the elevator unit 40 through an opening 72 of the housing 66 of the seed imaging assembly 50 (in the X-direction of the sampling module 12), such that the captured seed is located within the housing 66. In this position, a field of view of each of the cameras 68 includes a portion of the seed (e.g., multiple side portions of the seed, a bottom portion of the seed, etc.). And, the cameras 68 then each capture, or collect, one or more images of the seed. Once the desired images are captured/collected, the seed transport assembly 42 is configured to move the seed (via the transport carrier 58) to the seed sampling assembly 52 (again in the X-direction of the sampling module 12).

Then, based on the image data for the seed collected at the seed imaging assembly 50 (as evaluated by the control system 200, for example), the retention member 60 is configured to rotate the seed to a desired orientation prior to presenting the seed to the seed sampling assembly 52 for sampling. In particular, for example, in the illustrated embodiment the seed may be orientated by the retention member 60 so as to avoid an embryo of the seed during sampling operation in order to maintain seed viability. Alternatively, in various other embodiments, the seed may be oriented to actually target the embryo or to target a particular portion of the seed during the sampling operation. In general, the seed may be oriented to the desired orientation (at the retention member 60) based on desired or detectable genotypes, native or non-native traits, phenotypes, etc. including, for example, but not limited to, seed oil content, moisture content, color, geometry, geometry classification such as flat or round, or process outcome, etc. As an example, the seed may be oriented by the retention member 60 so that a cap or particular side of the seed is ultimately presented to the sampling assembly 52 for sampling (e.g., to a sampler 74 thereof, etc.).

With reference now to FIGS. 5 and 11-12, the seed sampling assembly 52 includes a seed grip assembly 76 and the sampler 74. The seed grip assembly 76 is configured to hold the seed in the sampling assembly 52 in a desired position and move the seed past the sampler 74 (e.g., in a Y-direction of the sampling module 12 as shown in FIG. 5, etc.) whereby the sampler removes a portion of tissue from the seed (e.g., a chunk, etc.). In connection therewith, the seed grip assembly includes a pair of generally opposing arms 78 and corresponding pads for securing/holding the seed therebetween (e.g., while the sampler 74 removes the tissue from the seed, etc.). An actuator 82 (e.g., a pneumatic clamp, etc.) is provided to bi-directionally move each of the respective of arms 78 and corresponding pads toward and away from each other, to thereby facilitate the securing/holding of the seed (and subsequent release thereof). In some embodiments, the pads of the seed grip assembly 76 are removable from the arms 78 so that replacement pads may be installed to the arms 78 and/or so that different pads may be installed to the arms 78 to accommodate different types of seeds, etc.

In the illustrated embodiment, the sampler 74 includes a cutting wheel 84 (e.g., a saw, etc.) (e.g., having a thickness of about 0.01 inches or less, etc.) operably coupled to a motor 86 for rotating the cutting wheel 84 during operation. The cutting wheel 84 may include teeth configured to remove tissue from the seed, or the cutting wheel 84 may include a sharpened edged (without teeth). The cutting wheel 84 is configured to rotate in a generally counter-clockwise direction (as viewed in FIG. 12). As such, as the seed grip assembly 76 moves (e.g., via the actuator 82, etc.) the seed past the cutting wheel 84, and the cutting wheel 84 engages the seed and removes the portion of tissue from the seed, the removed tissue is directed generally downward and into a sample collection funnel 88. In other example embodiments, systems may include samplers having features other than cutting wheels for removing tissue samples from seeds, for example, broaches, lasers, knives, etc.

The size and/or shape of the tissue sample removed by the cutting wheel 84 may be adjusted as desired (e.g., based on seed size, seed type, tissue testing, etc.). For example, the seed sampling module 12 may adjust the size/shape of tissue to be removed by controlling a position of the sampler 74 (and in particular the cutting wheel 84) relative to the seed grip assembly 76. In particular, the cutting wheel 84 may be adjusted (e.g., moved, etc.) in an X-direction of the sampling module 12 so that a larger or smaller amount of tissue is removed from the seed held in the seed grip assembly 76. Such adjustments may be based on input from a user at the control system 200, or such adjustments may be based on collected image data of the seed(s) from the seed imaging assembly 50.

In operation of the seed sampling assembly 52, after image data is collected by the seed imaging assembly 50 for the seed held in the seed transport assembly 42 and after the seed is oriented (or at about the same time or prior thereto), the seed transport assembly 42 is configured to move the seed to the seed sampling assembly 52 (again, in the X-direction of the sampling module 12). In so doing, the transport carrier 58 is configured to position the seed over the seed grip assembly 76, and the retention member 60 is configured to position the seed (e.g., lower the seed, etc.) generally between the arms 78 of the seed grip assembly 76. The seed grip assembly 76 is configured to then actuate the arms 78 together to grasp the seed therebetween. And, in turn, the retention member 60 is configured to release the seed (e.g., terminate any negative pressure suction applied thereto, etc.), and the seed transport assembly 42 returns to the elevator unit 40 to capture another seed. In this way, the seed is positioned, and held, by the seed grip assembly 76 in the same orientation as provided by the seed transport assembly 42. It should again be appreciated that the image data collected by the seed imaging assembly 50 may be used at the seed sampling assembly 52 to help position the seed between the arms 78 of the seed grip assembly 76 thereby controlling the exact location of tissue removal for the seed. In addition, or alternatively, the image data collected by the seed imaging assembly 50—maybe used at the seed sampling assembly to help position the sampler 74 thereby (further) controlling the exact location of tissue removal for the seed.

Once the seed is positioned between the arms 78 of the grip assembly 76, the grip assembly 76 moves the seed toward the sampler (again, in the Y-direction of the sampling module 12). In connection therewith, negative pressure is established in the sample collection funnel 88 (e.g., vacuum pressure, etc.) in preparation for capturing the tissue removed from the seed. The grip assembly 76 moves past the cutting wheel 84 of the sampler 74, whereby the cutting wheel 84 engages and removes (e.g., cuts, etc.) a protruding tissue portion of the seed. The removed tissue is directed generally downward by the rotation of the cutting wheel 84 and drawn into the sample collection funnel 88 via the negative pressure air flow. The grip assembly 76 then continues to move the seed to a seed collection funnel 90 (e.g., on an opposing side of the sampler 74, etc.), where the arms 78 release the seed into an inlet of the funnel 90. And, the grip assembly 76 returns to receive another singulated seed from the seed transport assembly 42.

In the illustrated embodiment, the seed sampling assembly 52 of the sampling module 12 may be configured to remove the tissue from the seed in a non-destructive manner such that germination viability of the seeds can be preserved. This is described in more detail hereinafter.

Referring now to FIGS. 5 and 13-17, the tissue removed from the seed at the seed sampling assembly 52 is captured (via the sample collection funnel 88) and transported (e.g., via gravity, air pressure, air jets, etc.) to a sample collection assembly 92 of the sampling module 12. Similarly, the seed from which the tissue is removed is captured (via the seed collection funnel 90) and transported (e.g., via gravity, air pressure, air jets, etc.) to a seed collection assembly 94 of the sampling module 12. In connection therewith, the tissue is collected in a sample plate 96 at the sample collection assembly 92 (e.g., in a specific well of the plate 96, etc.), and the seed is collected in a seed tray 98 at the seed collection assembly 94 (e.g., in specific well of the seed tray 98, etc.) so that a known relationship exists between the seed and the tissue removed therefrom. For example, one or more identifiers may be assigned to the seed and/or the tissue sample removed therefrom. As such, the seed and the tissue taken from the seed may be subsequently correlated (e.g., single seed identity may be maintained in the system 10, etc.). Further, through the identifiers, the various data captured by the system 10 for the given seed (e.g., the various image data, etc.), as well as subsequent tissue analysis data, may be associated with the proper seed, for example, at the control system 200, etc. As such, the tissue removed from the seed at the sampling module 12, and the corresponding seed, can be collected while maintaining single seed identity (including identity of the corresponding sample removed from the seed) in the system 10.

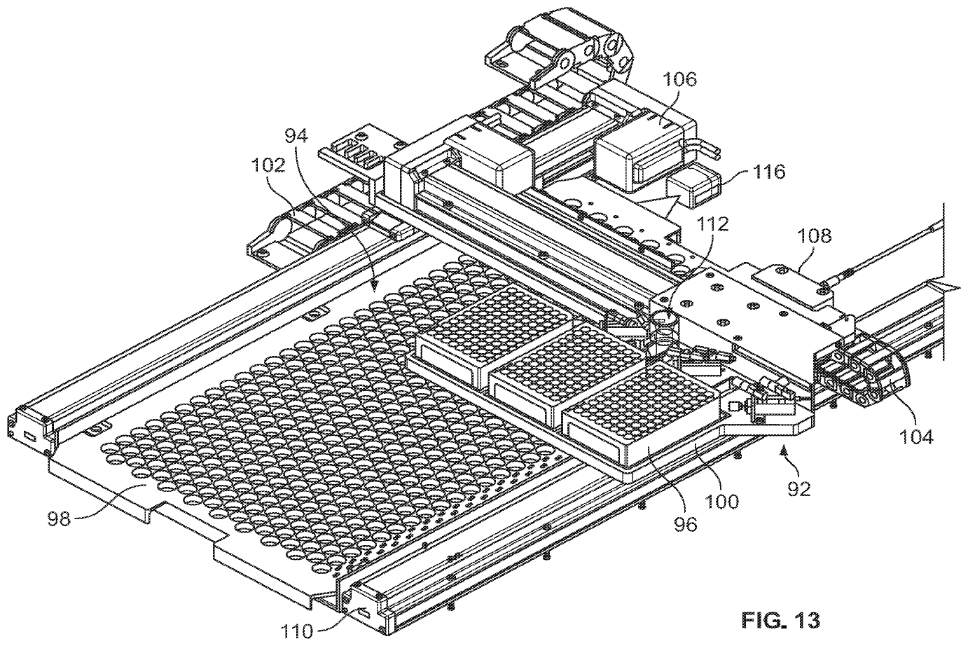

The sample collection assembly 92 includes a sample plate platform 100 adapted to securely retain the sample plate 96 (and other sample plates) in fixed positions and orientations. The sample plate platform 100 is mounted on an X-Y stage comprising an X-axis translating track 102 and a Y-axis translating track 104. Actuators 106, 108 (FIG. 13) then operate to bidirectionally move the sample plate platform 100 in the X-Y directions of the sampling module 12 by translating the tracks 102, 104 to desired positions relative to the sample collection funnel 88 (e.g., via drives, etc.). As such, the sample plate platform 100 is capable of moving wells of the sample plate 96 in the X-Y directions to particular positions under the sample collection funnel 88 to receive the tissue removed from the seed within a particular one of the wells.

In operation of the sample collection assembly 92, prior to the sampling assembly 52 removing tissue from the seed therein (as described above), the sample collection assembly 92 operates to move a well of sample plate 96 in the X-Y directions of the sampling module 12 (via the sample plate platform 100) to a particular position under the sample collection funnel 88 (e.g., to a target location under the sample collection funnel 88, etc.). Then, when the tissue is actually removed from the seed (as described above), the tissue falls (or, in some examples, is drawn by negative pressure, etc.) into the sample collection funnel 88 and is transported to the well of the sample plate 96 aligned with the sample collection funnel 88. Subsequently, the tissue received in the sample plate 96 can be utilized to test and analyze the various traits of the respective seed from which the tissue sample was removed (as described more hereinafter).

The seed collection assembly 94 includes a seed tray platform 110 adapted to securely retain the seed tray 98 in a fixed position and orientation thereon, and a seed deposit unit 112 disposed adjacent the sample plate platform 100 for directing the seed received from the seed collection funnel 90 to a desired well in the seed tray 98. In particular, the seed deposit unit 112 is configured to receive the seed from the seed collection funnel 90 and then deliver the seed (via movement of the seed deposit unit 112 on the platform 100) to a well of the seed tray 98, in a manner such that the seed can be subsequently identified to the particular tissue removed therefrom. In connection therewith, the seed collection funnel 90 and the seed deposit unit 112 may both include one or more gates to stage the seed (and, potentially, other seeds) therein so that only one seed is transferred from the seed collection funnel 90 to the seed deposit unit 112 at a given time, and so that only one seed is delivered from the seed deposit unit 112 to the well of the seed tray 98 at a given time.

In the illustrated embodiment, the seed tray platform 110 (and thus the seed tray 98 when positioned on the platform 110) is disposed generally below the X-Y stage. In this way, the tracks 102, 104 operate to bidirectionally move the seed deposit unit 112 (together with the sample plate platform 100) in the X-Y directions of the sampling module 12 to desired positions over (or above) the seed tray 98, so that the seed from which the tissue was removed is received within a particular one of the seed tray wells.

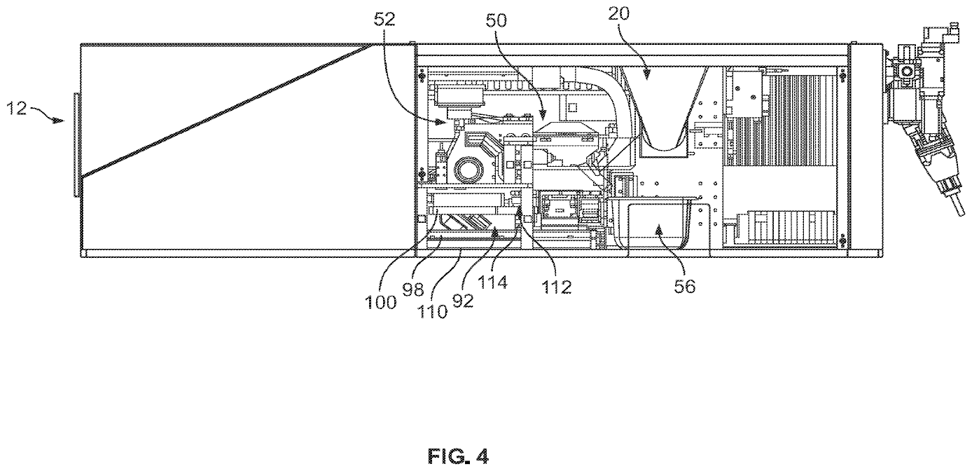

Further in the illustrated embodiment, an imaging device 114 (e.g., an imaging camera, a laser profiler, etc.) (FIG. 4) is associated with the seed collection assembly 94 and is disposed generally adjacent the seed deposit unit 112 to collect image data of the seed tray 98 positioned there below (and seeds received in wells of the seed tray 98). This image data may then be used, for example, to determine seed presence within wells of the seed tray 98 and may additionally be used to quantify the received seeds, their volume or weight, etc., and may even further be used to determine missed seed collection or seeds received in wrong wells. It should be appreciated that a similar imaging device may be associated with the sample collection assembly 92, for example, to determine tissue presence within wells of the sample plate 96, etc. In addition, scanner 117 is associated with the seed collection assembly 94 for reading an indicia/identification associated with the seed tray 98 (e.g., a bar code, etc.) to thereby identify the particular seed tray 98 (and seeds received therein), for example, to the control system 200, and/or to identify presence of the seed tray 98 in the platform 110.

In operation of the seed collection assembly 94, once the tissue is received from the seed sampling assembly 52 in a well of the sample plate 96, and the corresponding seed is received in the seed deposit unit 112 (from the seed collection funnel 90), the X-Y stage operates to move the seed deposit unit 112 (e.g., via the platform 100, etc.) over a desired well of the seed tray 98 (e.g., to a target location over the desired well of the seed tray 98, etc.). Then, the seed deposit unit 112 deposits (e.g., releases, actuates a gate to release, etc.) the seed in the aligned well. And, thereafter, the X-Y stage moves the sample plate platform 100 to align another well of the sample plate 96 in position under the sample collection funnel 88 to receive tissue removed from a next singulated seed at the seed sampling assembly 52.

In the illustrated embodiment, when the sample plate 96 is positioned on the sample plate platform 100 (e.g., manually, by the transfer unit 16, etc.).,a tray identification number (e.g., a barcode, etc.) for the plate 96 is recorded, via a scanner 115, etc., along with the location of the plate 96 on the platform 100 (as part of a given identifier for each of the tissue samples). Additionally, as tissue is received into a well of the sample plate 96, a specific X-Y location of the well (and thus the sample) can be recorded. The recorded sample plate 96 and well positions on the sample plate platform 100 can then be compared to the X-Y locations of each deposited sample of tissue, to map the specific samples in each well of the sample plate 96. Similarly, when the seed tray 98 is placed on the seed tray platform 110, a tray identification number (e.g., a barcode, etc.) for the seed tray 98 and the location of the seed tray 98 on the seed tray platform 110 is recorded (e.g., via scanner 116, etc.) (again, as part of a given identifier for each of the seeds). Additionally, as each seed is deposited in a well, an X-Y location of the well on the seed tray platform 110 can be recorded. The recorded tray and well positions on the seed tray platform 110 can then be compared to the X-Y locations of each deposited seed, to map the specific seed in each well of the seed tray 98. In this manner, the seeds received in the seed tray 98 can be linked to the tissue received in the sample plate 96.

With reference to FIGS. 1 and 17-18, the transfer unit 16 is configured to transfer seed trays and sample plates between the sampling modules 12 of the system 10 and a cart 118 disposed at (or in) the docking station 14, as desired (e.g., in preparation for sampling operation, after sampling operation, to transfer sampled seeds to other trays/containers as desired, etc.). For instance, in preparation for sampling operation, the transfer unit 16 may convey an empty seed tray from the cart 118 to the seed tray platform 110 of one of the sampling modules 12 and position the tray on the platform 110. This may be repeated for each of the sampling modules 12, as desired, as well as for seed trays. Then, once sampling is complete, the transfer unit 16 may convey the seed trays and/or sample plates from each of the sampling modules 12 back to the docking station 14 and position the trays in the cart 118 (or other corresponding cart(s), etc.). The transfer unit 16 may be configured to convey the trays in any order (e.g., sequentially, non-sequentially, a predefined order, etc.) or at random between the sampling modules 12 and the cart 118. In the illustrated embodiment, the transfer unit 16 includes a robotic arm configured to transfer the trays. It should be appreciated, though, that other transfer units may be used in other embodiments.

In the above example implementation, operation of the system 10 is described in connection with receiving a bulk amount of seeds in the hopper 20 and removing tissue samples (e.g., chunks, etc.) from the seeds (e.g., as a sampling or chipping operation, etc.). The tissue samples are then collected in wells of the sample plate 96, and the seeds from which the tissue samples are removed collected in wells of the seed tray 98. In connection therewith, in one example mode of such sampling operation, the sample plate 96 may include a 96 well F-plate (or multiple 96 well F-plates) (e.g., as shown in FIG. 13, etc.) and the seed tray 98 may include a 576 well HD tray (e.g., as shown in FIG. 13, etc.). In another example mode of such sampling operation (e.g., a continuous sampling mode, etc.), the sample plate 96 may again include a 96 well F-plate (or multiple 96 well F-plates) (e.g., as shown in FIG. 13, etc.) and the seed tray 98 may include a 24 well O-plate (or multiple 24 well O-plates) (e.g., as shown in FIG. 2, etc.).

In some example implementations of the present disclosure, the system 10 is configured (e.g., is operable, etc.) to receive a bulk amount of seeds in the hopper 20 and remove tissue samples (e.g., chunks, etc.) from the seeds, as described above. Then, in these implementations of the system 10, the tissue samples removed the seeds are collected in wells of the sample plate 96 such that multiple tissue samples (e.g., tissue samples removed from multiple ones of the seeds, etc.) are collected in each well of the sample plate 96 (e.g., the wells of the sample plate 96 each receive tissue samples from multiple different seeds, etc.) (e.g., as a bulk grinding operation, etc.). The seeds from which the tissue samples are removed may be collected in the seed tray 98 (as generally described above), or they may be discarded (e.g., directed to a collection container via the seed collection funnel 90, etc.). In connection with the above, the sample plate 96 may include a 96 well F-plate (or multiple 96 well F-plates) (e.g., as shown in FIG. 13, etc.). And, as described above, the multiple tissue samples received in each well of the sample plate 96 (e.g., an indication of the seeds from which the samples were removed, etc.) may be tracked and recorded by the control system 200 to thereby still provide for (and/or maintain) single seed identity in the system 10.

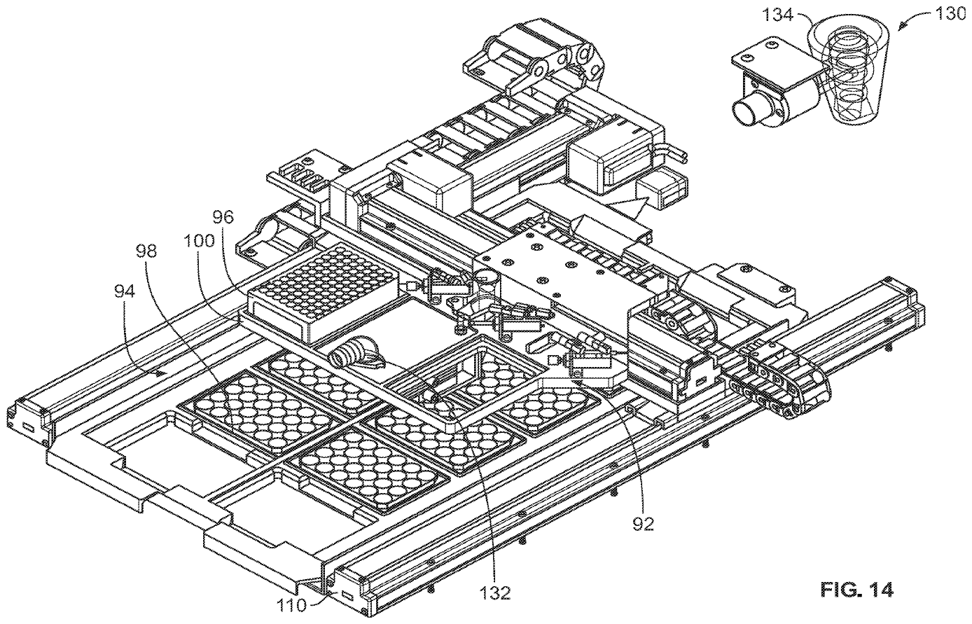

In addition, in some example some example implementations of the present disclosure, the transfer unit 16 is configured to convey a tray 98 of seeds from the cart 118 to one of the sampling modules 12 and position the tray 98 on the seed tray platform 110 of the module 12 (e.g., multiple 24 well O-plates in this example, etc.). The system 10 is then configured (e.g., is operable, etc.) to transport the seeds from the tray 98 out of the wells of the tray 98 transport the seeds to the elevator unit 40. For instance, as shown in FIG. 14, the system 10 may include a seed collector unit 130 configured to draw the seeds (via vacuum, etc.) out of the wells of the tray 98 and transfer (via vacuum, etc.) the seeds (through suitable conduit (not shown)) to the elevator unit 40. In particular, a collector 132 (e.g., a nozzle, etc.) may be coupled to the seed tray platform 110 and the seed platform may then be operated (e.g., via the control system 200, etc.) to position the collector 132 over desired wells of the seed tray 98. A vacuum source 134 coupled to the collector 132 (by way of the conduit (not shown) may then operate to draw the seeds out of the desired wells and direct the seeds to the elevator unit 40. The system 10 then operates as described above to remove tissue from the seed, deposit the tissue into a well of the sample plate 96, and deposit the seed back into the same well of the tray 98 (or into a well of another tray) on the seed platform 110. In this way, the system 10 is configured to maintain single seed identity of the seed as it is delivered to the system 10, as tissue is removed from the seed, and then as the seed is collected by and/or deposited back into the tray 98 (or another tray) on the seed tray platform 110, etc.

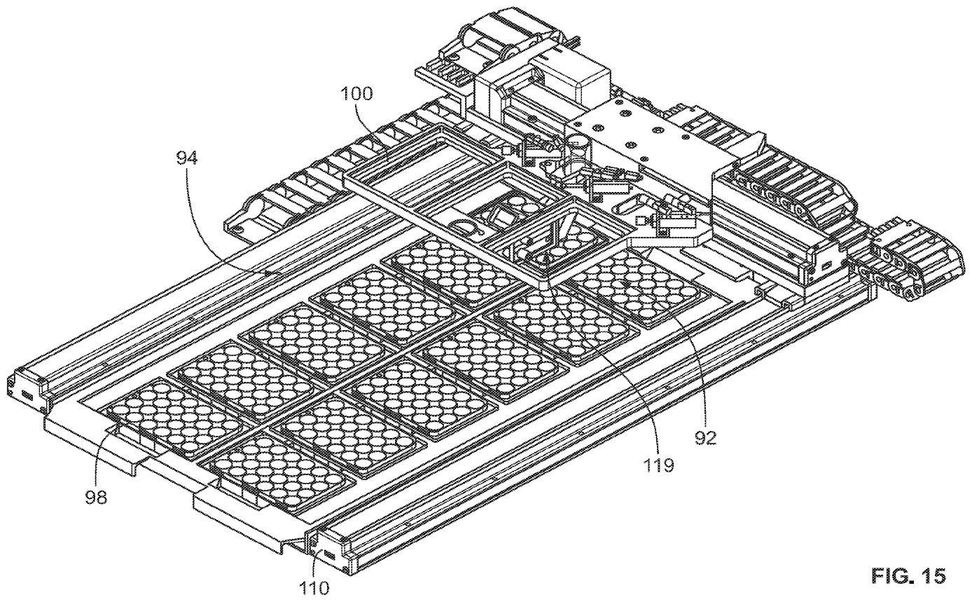

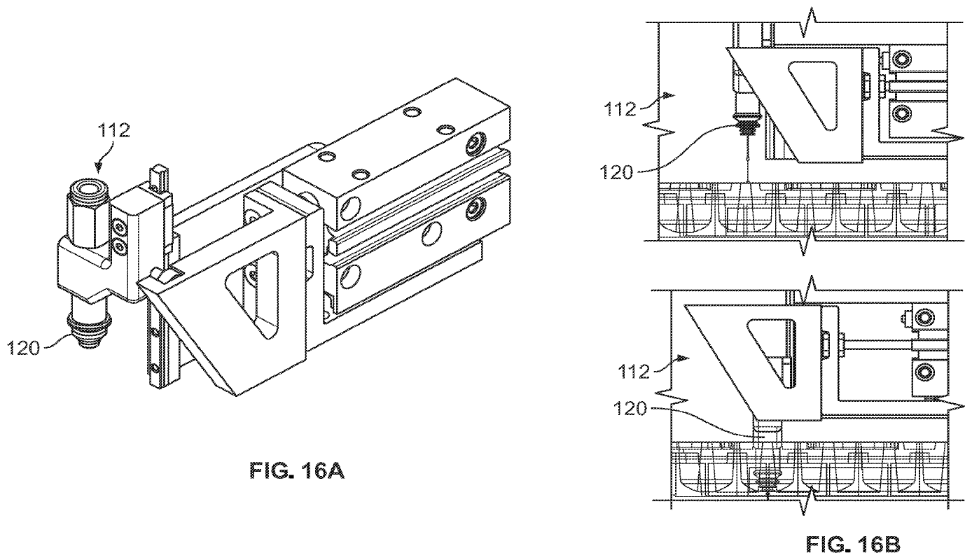

Further, in some example implementations of the present disclosure (see, FIGS. 15-16B), the transfer unit 16 is configured to convey a tray 98 of seeds from the cart 118 to one of the sampling modules 12 and position the tray 98 on the seed tray platform 110 of the module 12 (e.g., multiple 24 well O-plates in this example, etc.). The sampling module 12 may then operate to transfer seeds from select wells of the tray 98 to different wells of the tray, or to wells of a different tray (e.g., another 24 well O-plate, etc.) positioned on the seed tray platform 110, or to one or more different containers positioned on or adjacent the seed tray platform 110 (e.g., as part of a single channel seed offloading and/or sorting process). In particular, once the desired plate(s) is/are positioned on the seed tray platform 110, the X-Y stage of the sample plate platform 100 operates to move a seed transfer unit 119 (coupled generally under the platform 100) over a desired well of the seed tray 98. In turn, an end portion 120 of the seed transfer unit 119 is actuated toward the well (e.g., by the control unit 200, etc.) and draws (e.g., via vacuum, etc.) the seed out of the well (e.g., in a lateral direction via a piston 136, in a vertical direction via a plunger 138, etc.). Then, the X-Y stage of the sample plate platform 100 moves the seed transfer unit 119 to a position over another well of the plate (or over another well of another plate on the seed tray platform 110, or over another container), and again actuates the end portion 120 of the seed transfer unit 119 to release the seed into the new well (e.g., by terminating the vacuum to the end portion 120, etc.). In this way, the seed from the plate 98 may be repositioned in another location, for instance, with other seeds having similar traits, etc. so that the seeds may be accumulated and/or processed together. In these implementations, the system 10 may be used as a seed sorting system independent of removing tissue from the seeds in the tray 98 (e.g., in dependent of sample operation of the system 10, etc.), or in conjunction therewith.

As generally described above, it should again be appreciated that desired seed trays and/or sample plates may be used in the system 10. For instance, the sample plates may include 24-well plates (e.g., O-plates, etc.), 96-well plates (e.g., F-plates, etc.), etc. And, the seed trays may include 24-well plates, 96-well plates, 576 well trays (e.g., HD trays, etc.), etc.

As described above, seed sampling systems (e.g., system 10, etc.) and methods/operations of the present disclosure are operable to protect, preserve, etc. germination viability of sampled seeds and thus may, for example, be considered non-destructive. For example, the size, position and/or shape of the tissue samples removed may be controlled precisely to protect germination viability of the sampled seeds. Germination viability means that a predominant number of sampled seeds, (i.e., greater than about 50% of all sampled seeds) remain viable after sampling. In a particular embodiment, at least about 75% of sampled seeds, and in some embodiments at least about 95% of sampled seeds remain viable. It should be noted that lower rates of germination viability may be tolerable under certain circumstances or for certain applications, for example, as genotyping costs decrease with time because a greater number of seeds could be sampled for the same genotype cost. It should also be noted that sampling does not need to have any effect on viability at all.

In one embodiment, germination viability of the sampled seeds is maintained for at least about six months after sampling to ensure that the sampled seeds will be viable until they reach the field for planting. In a particular embodiment, the sampled seeds are further treated to maintain germination viability. Such treatment may generally include any means known in the art for protecting a seed from environmental conditions while in storage or transport. For example, in one embodiment, the sampled seeds may be treated with a polymer and/or a fungicide to protect the sampled seed while in storage or in transport to the field before planting.

Seed sampling modules (e.g., module 12, etc.) of the systems (e.g., system 10, etc.) of the present disclosure may define generally compact footprints (e.g., may define dimensions of about three feet by about four and a half feet, between about two feet and about four feet by between about three feet and about five feet, etc.). In addition, the sampling modules are configured to stack generally vertically so that multiple modules may be implemented in the same generally compact footprint. The compact footprint (and compact size) permits the system to be transported for operation at different locations.

Seed sampling and sorting systems (e.g., system 10, etc.) of the present disclosure are configured to accommodate different types of seeds and/or different sizes of seeds. For example, apertures of separating wheels may be configured to accommodate individual ones of different types and/or sizes of seeds so that the systems can be used to process different types of seeds without changing the separating wheels. In addition, end portions of retention members may be configured to retain individual ones of different types and/or sizes of seeds. And, samplers (and associated sampling modules) may be configured to sample individual ones of different types and/or sizes of seeds.

Example seeds that may be used with the seed sampling and sorting systems (e.g., system 10, etc.) and methods of the present disclosure include alfalfa seed, apple seed, banana seed, barley seed, bean seed, broccoli seed, cabbage seed, canola seed, carrot seed, castorbean seed, cauliflower seed, Chinese cabbage seed, citrus seed, clover seed, coconut seed, coffee seed, maize (or corn) seed, cotton seed, cucumber seed, Douglas fir seed, dry bean seed, eggplant seed, Eucalyptus seed, fennel seed, garden bean seed, gourd seed, leek seed, lettuce seed, Loblolly pine seed, linseed seed, melon seed, oat seed, okra seed, olive seed, onion seed, palm seed, pea seed, peanut seed, pepper seed, poplar seed, pumpkin seed, Radiata pine seed, radish seed, rapeseed seed, rice seed, rye seed, spinach seed, sorghum seed, squash seed, Southern pine seed, soybean seed, strawberry seed, sugarbeet seed, sugarcane seed, sunflower seed, sweet corn seed, sweetgum seed, tea seed, tobacco seed, tomato seed, turf seed, watermelon seed, wheat seed, and Arabidopsis thaliana seed. And, crops analyzed using the sampled seeds and/or tissue samples obtained as disclosed herein may include forage crops, oilseed crops, grain crops, fruit crops, ornamental plants, vegetable crops, fiber crops, spice crops, nut crops, turf crops, sugar crops, beverage crops, tuber crops, root crops, forest crops, etc.

Seeds and/or tissue (or tissue samples) obtained from the seeds using the seed sampling and sorting systems (e.g., system 10, etc.) and related methods of the present disclosure can be analyzed as desired. For example, the sampled seeds and/or their tissue samples can be analyzed for desired traits of interest (e.g., physical, chemical, morphological, and/or genetic characteristics; markers; genotypes; etc.), etc. Generally, such traits are determined by analyzing the samples for one or more characteristics indicative of at least one genetic or chemical trait. And, analyses may include ones for starch content, protein content, oil content, determination of fatty acid profiles, etc.

Seeds and/or tissue samples obtained from the seeds using the seed sampling and sorting systems (e.g., system 10, etc.) and related methods of the present disclosure can also be used to facilitate germplasm improvement activities. For example, the seeds and/or their tissue samples may be analyzed to identify and select seeds comprising one or more desired traits (including native or non-native traits), markers, haplotypes, and genotypes. In one aspect, analytical methods may be included with the seed sampling and sorting systems (e.g., system 10, etc.) and related methods of the present disclosure to allow individual seeds that are present in a batch or a bulk population of seeds to be analyzed such that the chemical and/or genetic characteristics of the individual seeds can be determined.

Non-limiting examples of traits of interest include color (e.g., white verses red, etc.), size, shape, seed type, resistance to pests (e.g., insects, mites, fungi, yeasts, molds, bacteria, nematodes, weeds, and parasitic and saprophytic plants, etc.), falling number score (e.g., Hagberg number, etc.), baking or noodle quality, etc.

More particularly, non-limiting examples of characteristics indicative of chemical traits include proteins, oils, carbohydrates, fatty acids, amino acids, biopolymers, pharmaceuticals, starch, fermentable starch, secondary compounds, metabolites, etc. Accordingly, non-limiting examples of chemical traits include amino acid content, protein content, protein composition, starch content, fermentation yield, fermentation efficiency, energy yield, oil content, determination of protein profiles determination of fatty acid profiles, determination of metabolite profiles, etc.

And, non-limiting examples of characteristics indicative of genetic traits may include, for example, genetic markers, single nucleotide polymorphisms, simple sequence repeats, restriction fragment length polymorphisms, haplotypes, tag SNPs, alleles of genetic markers, genes, DNA-derived sequences, RNA-derived sequences, promoters, 5′ untranslated regions of genes, 3′ untranslated regions of genes, microRNA, siRNA, quantitative trait loci (QTL), satellite markers, transgenes, mRNA, ds mRNA, transcriptional profiles, methylation patterns, ploidy numbers (or levels), etc.

In one embodiment, the seed sampling and sorting systems (e.g., system 10, etc.) and related methods of the present disclosure can be used for removing tissue samples from wheat seeds. The tissue samples can then be analyzed for any desired features (e.g., color (e.g., white verses red, etc.), protein composition, falling number score, baking or noodle quality, etc.). Based on this analysis (e.g., based on presence or absence of one or more desired feature, etc.), sampled wheat seeds can be selected for further use (e.g., further analysis, cultivation, packaging, use in breeding operations, etc.).

In one embodiment, the seed samples obtained using the seed sampling and sorting systems (e.g., system 10, etc.) and related methods include endosperm tissue which enables the determination of allele frequencies, whereby it is possible to infer parental linkage phase for a particular marker. Further, comparison of allele frequency data between two or more germplasm pools provides insight into the targets of selection, whereby alleles increasing in frequency in conjunction with a shift in distribution of one or more traits are presumed to be linked to said trait or traits of interest. Also, evaluation of relative allele frequency data between lines can contribute to the construction of genetic linkage maps.

In another embodiment, the seed samples obtained using the seed sampling and sorting systems (e.g., system 10, etc.) and related methods can be used with doubled haploid technologies to contribute to germplasm improvement activities including economization of doubled haploid programs by selecting only preferred seed for doubling. For example, the seed samples may be taken to include haploid and doubled haploid material and analyzed for both genotypic and chemical characteristics, and then used in connection with trait integration and evaluation and marker-assisted breeding.

Seeds and/or tissue samples obtained from the seeds using the seed sampling and sorting systems (e.g., system 10, etc.) and related methods of the present disclosure can also be used in a breeding program to select plants or seeds having a desired genetic or chemical trait, wherein a desired genetic trait comprises a genotype, a haplotype, an allele, a sequence, a transcript profile, and a methylation pattern. For example, the seeds and/or their tissue samples can be used in combination with any breeding methodology and can be used to select a single generation or to select multiple generations. The choice of breeding method depends on the mode of plant reproduction, the heritability of the trait(s) being improved, and the type of cultivar used commercially (e.g., F1 hybrid cultivar, pureline cultivar, etc.). Selected, non-limiting approaches for breeding the plants are set forth below. It is further understood that any commercial and non-commercial cultivars can be utilized in a breeding program. Factors including, for example, without limitation, emergence vigor, vegetative vigor, stress tolerance, disease resistance, branching, flowering, seed set, seed size, seed density, standability, and threshability will generally dictate the choice.

In a particular embodiment, the seeds and/or the tissue samples obtained from the seeds using the seed sampling and sorting systems (e.g., system 10, etc.) and related methods of the present disclosure are used to determine the genetic characteristics of seeds in a marker-assisted breeding program. This allows for improved marker-assisted breeding programs wherein direct seed sampling (such as disclosed herein) can be conducted while maintaining the identity of individual seeds from the seed sampling and sorting system (e.g., system 10, etc.) to the field. As a result, the marker-assisted breeding program results in a “high-throughput” and more efficient platform wherein a population of seeds having a desired trait, marker or genotype can be more effectively bulked in a shorter period of time, with less field and labor resources required. Such advantages will be more fully described below.

In some example embodiments, the seeds and/or the tissue samples obtained from the seeds using the seed sampling and sorting systems (e.g., system 10, etc.) and related methods of the present disclosure can be used in connection with processes for analyzing nucleic acids extracted from the seeds and/or samples for the presence or absence of at least one genetic marker. Desired seeds can then be selected, based on the results of the nucleic acid analysis, for example, for cultivating plants, etc. In connection therewith, the system 10 may be integrated with a corresponding tissue analysis unit, whereby the tissue samples removed from the seeds may be transported to the analysis unit in an automated fashion (e.g., sample plates may be transported to the analysis unit independent of human intervention, etc.).

For example, DNA may be extracted from the tissue samples using any DNA extraction methods known to those of skill in the art which will provide sufficient DNA yield, DNA quality, PCR response, and sequencing methods response. A non-limiting example of suitable DNA-extraction methods is SDS-based extraction with centrifugation. In addition, the extracted DNA may be amplified after extraction using any amplification method known to those skilled in the art. For example, one suitable amplification method is the GenomiPhi® DNA amplification prep from Amersham Biosciences.

In addition (or alternatively), RNA may be extracted from the tissue samples using any RNA extraction methods known to those of skill in the art which will provide sufficient RNA yield, RNA quality, PCR response, and sequencing methods response. A non-limiting example of suitable RNA-extraction methods is SDS-based extraction with centrifugation with consideration for RNase-free reagents and supplies. In addition, the extracted RNA may be amplified after extraction using any amplification method known to those skilled in the art. For example, one suitable amplification method is the Full Spectrum™ RNA Amplification from System Biosciences.

The extracted nucleic acids are analyzed for the presence or absence of a suitable genetic polymorphism. A wide variety of genetic markers for the analysis of genetic polymorphisms are available and known to those of skill in the art. As used herein, genetic markers include, but are not limited to, simple sequence repeats (SSRs), single nucleotide polymorphisms (SNPs), insertions or deletions (Indels), single feature polymorphisms (SFPs) or transcriptional profiles, and nucleic acid sequences. A nucleic acid analysis for the presence or absence of the genetic marker can be used for the selection of seeds in a breeding population. The analysis may be used to select for genes, QTL, alleles, or genomic regions (haplotypes) that comprise or are linked to a genetic marker. Herein, analysis methods are known in the art and include, but are not limited to, PCR-based detection methods (for example, TaqMan assays), microarray methods, and nucleic acid sequencing methods. The genes, alleles, QTL, or haplotypes to be selected for can be identified using newer techniques of molecular biology with modifications of classical breeding strategies.

In one of these example embodiments, sampled seeds are selected based on the presence or absence of one or more characteristics that are genetically linked with a QTL. Examples of QTLs which are often of interest include but are not limited to herbicide tolerance, disease resistance, insect or pest resistance, altered fatty acid, protein or carbohydrate metabolism, increased grain yield, increased oil, increased nutritional content, increased growth rates, enhanced stress tolerance, preferred maturity, enhanced organoleptic properties, altered morphological characteristics, other agronomic traits, traits for industrial uses, or traits for improved consumer appeal, or a combination of traits as a multiple trait index. Alternatively, the seeds can be selected based on the presence or absence of one or more characteristics that are genetically linked with a haplotype associated with a QTL. Examples of such QTL may again include without limitation herbicide tolerance, disease resistance, insect or pest resistance, altered fatty acid, protein or carbohydrate metabolism, increased grain yield, increased oil, increased nutritional content, increased growth rates, enhanced stress tolerance, preferred maturity, enhanced organoleptic properties, altered morphological characteristics, other agronomic traits, traits for industrial uses, or traits for improved consumer appeal, or a combination of traits as a multiple trait index.

Selection of a breeding population could be initiated as early as the F2 breeding level, if homozygous inbred parents are used in the initial breeding cross. An F1 generation could also be sampled and advanced if one or more of the parents of the cross are heterozygous for the alleles or markers of interest. The breeder may analyze an F2 population to retrieve the marker genotype of every individual in the population. Initial population sizes, limited only by the number of available seeds for analysis, can be adjusted to meet the desired probability of successfully identifying the desired number of individuals. Accordingly, the probability of finding the desired genotype, the initial population size, and the targeted resulting population size can be modified for various breeding methodologies and inbreeding level of the sampled population.

The selected seeds may be bulked or kept separate depending on the breeding methodology and target. For example, when a breeder is analyzing an F2 population for disease resistance, all individuals with the desired genotype may be bulked and planted in the breeding nursery. Conversely, if multiple QTL with varying effects for a trait such as grain yield are being selected from a given population, the breeder may keep individual identity preserved, going to the field to differentiate individuals with various combinations of the target QTL.

Several methods of preserving single seed identity can be achieved while transferring sampled seeds from the sampling location (e.g., from the seed sampling and sorting system 10, etc.) to the field. Methods include, but are not limited to, transferring selected individuals (e.g., directly from the seed sampling and sorting system 10, etc.) to trays (e.g., seed trays, etc.), seed tapes, a cassette trays, indexing trays, or transplanting the sampled seeds with peat pots, and hand-planting from individual seed packets 21, or direct labeling of individual seeds (e.g., via inkjet printing, or laser engraving, etc.) with numeric, alpha, or alphanumeric characters or barcodes.

Multiple cycles of selection can be utilized depending on breeding targets and genetic complexity.

Advantages of using the seed sampling and sorting systems (e.g., system 10, etc.) and related methods of the present disclosure (including the analytic and seed breeding methods) include, without limitation, reduction of labor and field resources required per population or breeding line, increased capacity to evaluate a larger number of breeding populations per field unit, and increased capacity to analyze breeding populations for desired traits prior to planting. Field resources per population are reduced by limiting the field space required to advance the desired genotypes. For example, a population of 1,000 individuals may be planted at 25 seeds per row consuming a total of 40 rows in the field. Using conventional tissue sampling, all 1,000 plants would be tagged and manually sampled by scoring leaf tissue. Molecular marker results would be needed prior to pollination and only those plants containing the desired genetic composition would be pollinated. Thus, if it was determined that 50 seeds contained the desired genetic composition, conventional breeding methodology would have required the planting of 1000 plants to retain the desired 50 seeds. By contrast, the present disclosure allows the breeder to analyze the 1,000 seeds in the lab and select the 50 desired seeds prior to planting. The 50 individuals can then be planted in the field, consuming only two 25 seed rows. Additionally, the present disclosure allows the breeder to avoid tagging or sampling in the field, thereby significantly reducing the required manual labor resources.

In addition to reducing the number of field rows per population, using the seed sampling and sorting systems (e.g., system 10, etc.) and related methods of the present disclosure (including the analytic and seed breeding methods) may further allow for increasing the number of populations the breeder can evaluate in a given breeding nursery. Using the above example wherein 50 seeds out of each population of 1000 seeds contained the desired genetic composition, a breeder applying the technology of the present disclosure could evaluate 20 populations of 50 seeds each using the same field area consumed by a single population using conventional field tissue sampling techniques. Even if the populations are selected for a single allele, using a 1:2:1 expected segregation ratio for an F2 population, the breeder could evaluate 4 populations in the same field area as a single field tissue sampled population.

A potential further advantage to using the seed sampling and sorting systems (e.g., system 10, etc.) and related methods of the present disclosure (including the analytic and seed breeding methods) is the mitigation of risks associated with growing plants in certain geographies where plants may grow poorly or experience poor environmental conditions, or may even be destroyed during storms. For example, seeds with the “best” genotype or marker composition could be planted in geography 1 and seeds with the “next best” genotype could be planted in geography 2. In this case geography 2 would be a backup in case any problem befell the plants grown in geography 1. This is very difficult to do with the traditional method of taking tissue samples from germinated plants for genotyping, because these plants would then need to be uprooted and transplanted to the second geography. Using the seed sampling and sorting systems (e.g., system 10, etc.) and related methods of the present disclosure (including the analytic and seed breeding methods) avoids the problem of transplantation and also simplifies the logistics of the breeding program.

In some embodiments, the seed sampling and sorting systems (e.g., system 10, etc.) and related methods of the present disclosure (including the analytic and seed breeding methods) may further be used in a breeding program for introgressing a trait into a plant. Here, nucleic acids extracted from the tissue samples are analyzed for the presence or absence of at least one genetic marker. Seeds are then selected based on the results of the nucleic acids analysis, and plants are cultivated from the selected seeds. The cultivated plants can then be used as either female parents or male parents in crosses with other plants.

Examples of genetic analyses to select seeds for trait integration include, without limitation, identification of high recurrent parent allele frequencies, tracking of transgenes of interest or screening for the absence of unwanted transgenes, selection of hybrid testing seed, selection of seed expressing a gene of interest, selection of seed expressing a heritable phenotype, identification of seed with selected genetic loci, and zygosity testing.

The identification of high recurrent pair allele frequencies using the seed sampling and sorting systems (e.g., system 10, etc.) and related methods of the present disclosure (including the analytic and seed breeding methods) again allows for a reduced number of rows per population and an increased number of populations, or inbred lines, to be planted in a given field unit. Thus, the present disclosure may also effectively reduce the resources required to complete the conversion of inbred lines.

The seed sampling and sorting systems (e.g., system 10, etc.) and related methods of the present disclosure and tissue samples obtained therefrom (and the described analytic and seed breeding methods) further provide quality assurance (QA) and quality control (QC) by assuring that regulated or unwanted transgenes, undesirable genetic traits, or undesirable inherited phenotypes are identified and discarded prior to planting. This application in a QA capacity could effectively eliminate unintentional release infractions. A further extension of the present disclosure is to screen for the presence of infectious agents and remove contaminated seed prior to shipping.

The seed sampling and sorting systems (e.g., system 10, etc.) and related methods of the present disclosure (and the described analytic and seed breeding methods) may be further applied to identify hybrid seed for transgene testing. For example, in a conversion of an inbred line at the BCnF1 stage, a breeder could effectively create a hybrid seed lot (barring gamete selection) that was 50% hemizygous for the trait of interest and 50% homozygous for the lack of the trait in order to generate hybrid seed for testing. The breeder could then analyze all F1 seeds produced in the test cross and identify and select those seeds that were hemizygous. Such method is advantageous in that inferences from the hybrid trials would represent commercial hybrid genetics with regard to trait zygosity.

In one example, systems and methods of the present disclosure may be used for evaluating transgenic seeds for segregation distortion. Seeds of an F1 cross between Line A (Homozygous Event 1 and Event 2) and Line B (Homozygous Event 1) were induced in a maternal haploid induction isolation. The resulting kernels were selected using plumule color to obtain a population of putative haploid seed.

Individual putative haploid kernels from the population of putative haploid seed may be selected and non-destructively sampled using an automated seed sampler system (e.g., the seed sampling and sorting system 10 as generally described herein, etc.). Markers were applied to the samples to determine the presence of the Event 2 gene and the Event 1 gene. The sampling process may remove some pericarp and endosperm tissue and use this as the base for analysis. It is important to note that endosperm tissue is triploid and contains genetic contribution from both parents. If the gene of interest is detected using this method, it accurately predicts the presence of the desired gene in the haploid embryo. For the purposes of this study, samples from 180 kernels were analyzed and data were obtained on 175 due to sampling issues. In connection therewith (and as mentioned above), the system 10 may enable embryo targeted sampling/tissue removal to generate true doubled haploid genetic information, without inducer genome presence (triploid nature).

As shown in Table 1, each of the seed samples tested positive for the Event 1 gene as expected and approximately 50% of the seed samples tested positive for the Event 2 gene, confirming no segregation distortion.

TABLE 1

| Pedigree | Event 2 | Event 1 |
|---|---|---|
| Chromosome | 6 | 8 |
| Position | 38 | 63 |
| Parental Checks | | |
| Line A | Pos | Pos |
| Line B | Neg | Pos |
| KHI1 | Neg | Neg |
| Selected Kernels | 175 | 175 |
| Total Positive | 92/175 | 175/175 |
| Total Negative | 83/175 | 0/175 |

Results of this study indicate that individual gene traits can be selected on a haploid basis using high throughput, nondestructive seed sampling as a screening mechanism.

Other applications of the seed sampling and sorting systems (e.g., system 10, etc.) and related methods of the present disclosure (including the described analytic and seed breeding methods) include use in identifying, tracking, and stacking traits of interest, which carry the same advantages identified above with respect to required field and labor resources. Generally, transgenic conversion programs are executed in multi-season locations which carry a much higher land and management cost structure. As such, the impact of either reducing the row needs per population or increasing the number of populations within a given field unit are significantly more dramatic on a cost basis versus temperate applications.

The seed sampling and sorting systems (e.g., system 10, etc.) and related methods of the present disclosure (including the described analytic and seed breeding methods) may also be used for seeds from plants with two or more transgenes, wherein accumulating or stacking of transgenic regions into plants or lines is achieved by addition of transgenes by transformation, or by crossing parent plants or lines containing different transgenic regions, or any combination of these. Analyses can be conducted to select individual seeds on the basis of the presence of one or more characteristics associated with at least one transgene. Such characteristics include, but are not limited to, a transgene per se, a genetic marker linked to a transgene, mRNA expressed from a transgene, and a protein product of a transgene.

Still further, the seed sampling and sorting systems (e.g., system 10, etc.) and related methods of the present disclosure (including the described analytic and seed breeding methods) may be used to improve the efficiency of the doubled haploid program through selection of desired genotypes at the haploid stage and identification of ploidy level to eliminate non-haploid seeds from being processed and advancing to the field. Both applications again result in the reduction of field resources per population and the capability to evaluate a larger number of populations within a given field unit.

Doubled haploid (DH) plants provide an invaluable tool to plant breeders, particularly for generating inbred lines. A great deal of time is spared as homozygous lines are essentially instantly generated, negating the need for multigenerational conventional inbreeding.

In particular, because DH plants are entirely homozygous, they are very amenable to quantitative genetics studies. Both additive variance and additive x additive genetic variances can be estimated from DH populations. Other applications include identification of epistasis and linkage effects. For breeders, DH populations have been particularly useful in QTL mapping, cytoplasmic conversions, and trait introgression. Moreover, there is value in testing and evaluating homozygous lines for plant breeding programs. All the genetic variance is among progeny in a breeding cross, which improves selection gain.

However, it is well known in the art that DH production process is inefficient and can be quite labor-intensive. While doubled haploid plants can occur spontaneously in nature, this is extremely rare. Most research and breeding applications rely on artificial methods of DH production. The initial step involves the haploidization of the plant which results in the production of a population comprising haploid seed. Non-homozygous lines are crossed with an inducer parent, resulting in the production of haploid seed. Seed that has a haploid embryo, but normal triploid endosperm, advances to the second stage. That is, haploid seed and plants are any plant with a haploid embryo, independent of the ploidy level of the endosperm.

After selecting haploid seeds from the population, the selected seeds undergo chromosome doubling to produce doubled haploid seeds. A spontaneous chromosome doubling in a cell lineage will lead to normal gamete production or the production of unreduced gametes from haploid cell lineages. Application of a chemical compound, such as colchicine, can be used to increase the rate of diploidization. Colchicine binds to tubulin and prevents its polymerization into microtubules, thus arresting mitosis at metaphase, can be used to increase the rate of diploidization, i.e. doubling of the chromosome number. These chimeric plants are self-pollinated to produce diploid (doubled haploid) seed. This DH seed is cultivated and subsequently evaluated and used in hybrid testcross production.

However, processes for producing DH seed generally suffer from low efficacy even though methods have been developed in an attempt to increase DH production frequency, including treatment with colchicines. Outstanding issues include low production of haploid seed, reduced gamete viability resulting in diminished self-pollination for DH plant generation, and inadequate DH seed yield for breeding applications.

The seed sampling and sorting systems (e.g., system 10, etc.) and related methods of the present disclosure (including the described analytic and seed breeding methods) represent an advance in breeding applications by facilitating the potential for selection at the haploid as well as the diploid seed stage. For example, the seed sampling and sorting systems (e.g., system 10, etc.) and related methods of the present disclosure (including the described analytic and seed breeding methods) can provide for the high-throughput sampling of an entire population of haploid seed, and allow for the subsequent analysis of the samples removed from the seeds. This can also provide for the high-throughput bulking of an entire population of doubled haploid seeds. The samples may be analyzed for the presence or absence of one or more characteristics indicative of at least one genetic or chemical trait and, based on the results of the analysis, one or more individual doubled haploid seeds can then be selected, and plants or plant tissue can be cultivated from the selected doubled haploid seeds.

The seed sampling and sorting systems (e.g., system 10, etc.) and related methods of the present disclosure (including the described analytic and seed breeding methods) can also include operations associated therewith for analyzing seeds for one or more characteristics, such as, for example, genetic markers, transgenes, markers linked to or diagnostic of transgenes, characteristics related to event performance, event evaluation, and trait integration, etc. to determine whether the seeds are in a haploid or diploid state and/or to select preferred genotypic and phenotypic classes to undergo doubling.

In another embodiment, the seed sampling and sorting systems (e.g., system 10, etc.) and related methods of the present disclosure (including the described analytic and seed breeding methods) can be used with operations for determining linkage phase. By using seed endosperm tissue derived from a diploid plant, the parental marker haplotypes can be determined using a genotyping system that enables detection of different allele frequencies in DNA samples. Since endosperm tissue is triploid, with two copies derived from the female gamete, the linkage phase of the parental line can be derived by dissecting heterozygous progeny genotypes. The DNA sample from endosperm tissue allows for a determination of the ploidy level of the genetic marker. A diploid ploidy level in the genetic marker indicates maternal inheritance and a haploid ploidy level in the genetic marker indicates paternal inheritance.

Further, differential allele frequency data can be used to infer the genetic linkage map but, unlike methods requiring haploid material, using the above-described allele frequency calling. Determination of the genetic linkage map has tremendous utility in the context of haplotype characterization, mapping of marker (or haplotype)—trait associations. This is particularly robust on a single, vs. bulked, seed basis and is thus well-suited for use in association with the seed sampling and sorting systems (e.g., system 10, etc.) and related methods of the present disclosure (including the described analytic and seed breeding methods).

In another embodiment, the seed sampling and sorting systems (e.g., system 10, etc.) and related methods of the present disclosure (including the described analytic and seed breeding methods) may further be used in connection with an assay for predicting embryo zygosity for a particular gene of interest (GOI). The assay predicts embryo zygosity based on the ratio of the relative copy numbers of a GOI and of an internal control (IC) gene per cell or per genome. Generally, this assay uses an IC gene that is of known zygosity, e.g., homozygous at the locus (two IC copies per diploid cell), for normalizing measurement of the GOI. The ratio of the relative copy numbers of the IC to the GOI predicts the GOI copy number in the cell. In a homozygous cell, for any given gene (or unique genetic sequence), the gene copy number is equal to the cell's ploidy level since the sequence is present at the same locus in all homologous chromosomes. When a cell is heterozygous for a particular gene (or hemizygous in the case of a transgene), the gene copy number will be lower than the cell's ploidy level. If the GOI is not detected, the cell is null for the locus, as can happen for a negative segregant of a transgenic event or in a mutagenized population. The zygosity of a cell at any locus can thus be determined by the gene copy number in the cell.

In a particular embodiment, the seed sampling and sorting systems (e.g., system 10, etc.) and related methods of the present disclosure (including the described analytic and seed breeding methods) may be used in connection with an assay for predicting corn embryo zygosity. In corn seed, the endosperm tissue is triploid, whereas the embryo tissue is diploid. Endosperm copy number is reflective of the zygosity of the embryo: a homozygous (positive or negative) endosperm accompanies a homozygous embryo, heterozygous endosperm (whether a GOI copy number of 1 or 2) reflects a heterozygous (GOI copy number of 1) embryo. Endosperm that is homozygous for the IC will contain three IC copies. Endosperm GOI copy number can range from 0 (homozygous negative embryo) to 3 (homozygous positive embryo); and endosperm GOI copy number of 1 or 2 is found in seed where the embryo is heterozygous for the GOI (or hemizygous for the GOI if the GOI is a transgene). The endosperm GOI copy number (which can range from 0 to 3 copies) can be determined from the ratio of endosperm IC copy number to endosperm GOI copy number (which can range from 0/3 to 3/3, that is, from 0 to 1), which can then be used to predict zygosity of the embryo.

Copy numbers of the GOI or of the IC can be determined by any convenient assay technique for quantification of copy numbers, as is known in the art. Examples of suitable assays include, but are not limited to, Real Time (TaqMan®) PCR (Applied Biosystems, Foster City, CA) and Invader® (Third Wave Technologies, Madison, WI) assays. Preferably, such assays are developed in such a way that the amplification efficiency of both the IC and GOI sequences are equal or very similar. For example, in a Real Time TaqMan® PCR assay, the signal from a single-copy GOI (the source cell is determined to be heterozygous for the GOI) will be detected one amplification cycle later than the signal from a two-copy IC, because the amount of the GOI is half that of the IC. For the same heterozygous sample, an Invader® assay would measure a GOI/IC ratio of about 1:2 or 0.5. For a sample that is homozygous for both the GOI and the IC, the GOI signal would be detected at the same time as the IC signal (TaqMan®), and the Invader assay would measure a GOI/IC ratio of about 2:2 or 1.

These guidelines apply to any polyploid cell, or to haploid cells (such as pollen cells), since the copy number of the GOI or of the IC remain proportional to the genome copy number (or ploidy level) of the cell. Thus, these zygosity assays can be performed on triploid tissues such as corn endosperm. Furthermore, the copy number for a GOT can be measured beyond 2 copies or at numerically different values than the ploidy of the cell. The method is still appropriate for detecting GOI in polyploids, in some transgenic events with >2 copies of the inserted transgene, after replication of the GOI by transposition, when the GOI exists on autonomously replicating chromosomes or plasmids and other situations.

In plant breeding, it is useful to determine zygosity at one or more loci for the purpose of evaluating the level of inbreeding (that is, the degree of gene fixation), segregation distortion (i.e., in transgenic germplasm, maternal inheritance testing or for loci that affect the fitness of gametes), and the level of outbreeding (i.e., the relative proportion of homozygosity and heterozygosity). Similarly, the extent of zygosity at one or more loci can be used to estimate hybridity and whether a particular seed lot meets a commercial or regulatory standard for sale as certified hybrid seed. In addition, in transgenic germplasm, it is useful to know the ploidy, or copy number, in order to distinguish between quality events and to aid in trait integration strategies.

In another embodiment, the seed sampling and sorting systems (e.g., system 10, etc.) and related methods of the present disclosure (including the described analytic and seed breeding methods) may be used in connection with operations for improving the ability to monitor one or more germplasm pools for shifts in the frequencies of one or more genetic characteristics, wherein said genetic characteristics include markers, alleles, and haplotypes. Methodology is known in the art to compare genetic marker frequency between recently derived populations and their ancestral lines in order to identify those genetic loci that are increasing in frequency over time (U.S. Pat. Nos. 5,437,697 and 5,746,023). Those loci with frequencies that exceed the expected allele frequency are inferred to have been subject to selection. Further, given that the predominant selection criterion in breeding programs is yield, it is expected that those increasingly frequent alleles may be linked to yield.

In a particular embodiment, the seed sampling and sorting systems (e.g., system 10, etc.) and related methods of the present disclosure (including the described analytic and seed breeding methods) may be used in connection with operations to enable haplotype-assisted breeding. By comparing the frequency of haplotypes in emerging elite lines with the haplotype frequency in the ancestral elite lines (as determined via pedigree analysis), identification of haplotypes that are deviating from the expected haplotype frequency is possible. Further, by evaluation of haplotype effect estimates for said haplotypes, it is also possible to link said haplotypes of increasing frequency with phenotypic outcomes for a suite of agronomic traits. The haplotype composition of individual seeds sampled from a plurality of seeds can be determined using genetic markers and the seeds with preferred haplotypes are selected and advanced. Thus, more informed breeding decisions and establishment of superior line development programs is enabled by this technology.

Operation of the system 10, and of the seed sampling modules 12, the docking station 14, and the transfer unit 16 is automated, in this example embodiment, and may be controlled (and/or coordinated), for example, by central control system 200 (broadly, a computing device, etc.) within the scope of the present disclosure (see, e.g., FIGS. 19 and 20, etc.). In connection therewith, FIG. 19 illustrates an example relationship between the seed sampling and sorting system 10 and corresponding control system 200. As shown, in this example, the seed sampling and sorting system 10 is coupled to (and is in communication with) the control system 200 via network 202, to facilitate the communication and interaction described above. And, in connection therewith, the network 202 may include, without limitation, a local area network (LAN), a wide area network (WAN) (e.g., the Internet, etc.), a mobile network, a virtual network, and/or another suitable public and/or private network capable of supporting communication among the seed sampling and sorting system 10 and the control system 200, or any combination thereof. Alternatively, as indicated by the dotted line in FIG. 19, the seed sampling and sorting system 10 may be directly coupled to (and in communication with) the control system 200, for example, via a wired connection, etc. (e.g., the control system 200 may be an integral part of the seed sampling system 10, etc.).

FIG. 20 illustrates an example computing device 300 that can be used in connection with the seed sampling and sorting system 10 and the control system 200. The computing device 300 may include, for example, one or more servers, workstations, personal computers, laptops, tablets, smartphones, etc. In addition, the computing device 300 may include a single computing device, or it may include multiple computing devices located in close proximity or distributed over a geographic region, so long as the computing devices are specifically configured to function as described herein. In the example embodiment of FIG. 20, each of the seed sampler and sorting system 10 and the control system 200 may be considered as including and/or being implemented in at least one computing device consistent with computing device 300. However, the present disclosure is not limited to the computing device 300, as described below, as different computing devices and/or arrangements of computing devices and/or arrangement of components associated with such computing devices may be used.

Referring to FIG. 20, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may be configured to store, without limitation, the various data (and/or corresponding data structures) described herein. Furthermore, in various embodiments, computer-executable instructions may be stored in the memory 304 for execution by the processor 302 to cause the processor 302 to perform one or more of the functions described herein, such that the memory 304 is a physical, tangible, and non-transitory computer readable storage media. Such instructions often improve the efficiencies and/or performance of the processor 302 and/or other computer system components configured to perform one or more of the various operations herein. It should be appreciated that the memory 304 may include a variety of different memories, each implemented in one or more of the functions or processes described herein.

In the example embodiment, the computing device 300 also includes a presentation unit 306 that is coupled to (and is in communication with) the processor 302 (however, it should be appreciated that the computing device 300 could include output devices other than the presentation unit 306, etc.). The presentation unit 306 outputs information to users of the computing device 300 as desired. And, various interfaces (e.g., as defined by network-based applications, etc.) may be displayed at computing device 300, and in particular at presentation unit 306, to display such information. The presentation unit 306 may include, without limitation, a liquid crystal display (LCD), a light-emitting diode (LED) display, an organic LED (OLED) display, an “electronic ink” display, speakers, etc. In some embodiments, the presentation unit 306 may include multiple devices.

In addition, the computing device 300 includes an input device 308 that receives inputs from the users of the computing device 300. The input device 308 may include a single input device or multiple input devices. The input device 308 is coupled to (and is in communication with) the processor 302 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both a presentation unit and an input device.

Further, the illustrated computing device 300 also includes a network interface 310 coupled to (and in communication with) the processor 302 and the memory 304. The network interface 310 may include, without limitation, a wired network adapter, a wireless network adapter, a mobile network adapter, or other device capable of communicating to one or more different networks, including the network 202, and/or the seed sampler system 10. Further, in some example embodiments, the computing device 300 may include the processor 302 and one or more network interfaces incorporated into or with the processor 302.

FIGS. 21-27 illustrate example docking stations 402-408 that may be used with the seed sampling and sorting system 10 of the present disclosure. In connection therewith, and as generally described above, the transfer unit 16 is operable to access each of the docking stations 402-408, as desired (e.g., via instruction by the control system 200, etc.) and thereby interact with the docking stations 402-408 and the sampling modules 12 in connection with the various operations and/or modes described herein.

The docking station 402 generally includes a cart 418 (e.g., a wheeled cart, etc.) configured to hold seed trays (e.g., seed trays 98 in a similar manner to docking station 14 and cart 118 illustrated in FIG. 1, etc.) for use with the sampling modules 12 (e.g., at a location generally apart from the sampling modules 12, etc.). In particular, in the illustrated embodiment, the docking station 402 (e.g., the cart 418 thereof, etc.) is configured to hold HD seed trays for use with the sampling modules 12. As such, HD seed trays may be initially filled with seeds and positioned in the docking station 402. Then, when desired to process the seeds in the HD seed trays (e.g., remove tissue from the seeds, sort the seeds, etc.), the transfer unit 16 is operated (via the control system 200) to engage one or more of the desired trays in the docking station 402 and transfer the tray(s) to the seed tray platform 110 of the seed collection assembly 94 of the desired one of the sampling modules 12. The sampling module(s) 12 then operate(s) as described above. In doing so, an end portion 140 of the transfer unit 16 includes an attachment 142 (e.g., a tool, etc.) defining an opening or recess (see, e.g., FIG. 18) configured to receive at least part of the HD seed tray therein to allow for moving the HD seed tray between the docking station 402 and the sampling modules 12. The illustrated transfer unit 16 also includes a second arm, for example, for use in removing a lid from a tray, etc. (as shown, for example, in FIG. 18).

The docking station 404 generally includes a cart 418 configured to hold sample plates (e.g., sample plates 96, etc.), as well as seed tray lids and other containers for receiving samples removed from seeds, etc. In particular, in the illustrated embodiment, the docking station 402 is configured to hold F-plates 450 (broadly, sample plates) for use with the sampling modules 12. As such, the F-plates may be initially positioned in the docking station 402. Then, when desired to process seeds in the samplers 12 (e.g., remove tissue from the seeds, etc.), the transfer unit 16 is operated (via the control system 200) to engage one or more of the desired F-plates 450 in the docking station 404 and transfer the F-plates 450 to the sample plate platform 100 of the sample collection assembly 92 (of the desired one of the sampling modules 12). The sampling module(s) 12 then operate(s) as described above (e.g., to remove tissue samples from desired seeds and deliver the tissue samples to the wells of the F-plates 450, etc.). In doing so, the end portion 140 of the transfer unit 16 may include an attachment defining a recess configured to receive at least part of the F-plate 450 therein (e.g., particularly configured to receive the F-plate 450, etc.) to allow for moving the F-plate 450 between the docking station 404 and the sampling modules 12. As indicated, the illustrated docking station 404 is also shown holding seed tray lids 452 (e.g., removed from the seed trays by the transfer unit 16 when transporting the seed trays from the docking station 402 to the sampling modules 12, etc.) and sample containers 454 for receiving tissue samples removed from seeds, as desired (e.g., as part of the bulk grinding operation of the system 10, etc.).

The docking station 406 includes a cart 418 configured to stack the sample plates delivered thereto, for example, by the transfer unit 16. For instance, once tissue samples are received in the wells of the sample plates (at the sample modules 12), the transfer unit 16 may be configured to remove the sample plates from the sampling modules 12 and deliver the sample plates to the docking station 406. In ding so, the docking station 406 is arranged to receive the sample plates and stack them for subsequent processing, etc. For instance, the docking station 406 includes multiple rack units 456 around generally around the docking station 406. Each of the rack units 456 is then associated with a support 458. As such, the sample plates may be positioned on the supports 458 with in the rack units 456 and thereby stacked for subsequent use/processing (e.g., for delivery of the tissue samples to a testing location for testing, etc.).

The docking station 408 includes a cart 418 configured to hold different attachments 142 (e.g., tools, robotic attachments, etc.) for use by the transfer unit 16 in transferring different seed trays and sample plates between the docking stations 402-406 and the samplers 12 (e.g., each of the different attachments 142 may be specifically configured for holding different types of the seed trays (e.g., HD trays, O-plates, etc.), sample plates (F-plates, etc.), containers (e.g., seed jars, sample jars, etc.), etc. described herein; etc.). In connection therewith, the attachments 142 are positioned on a support 460 such that the attachments 142 are accessible by the transfer unit 16 as needed. In particular, the attachments 142 are each configured to couple to the end portion 140 of the transfer unit 16 to thereby accommodate the different trays, plates, containers, etc. that may be used by the samplers 12 in the various operations described herein. The attachments 142 may automatically couple to the end portion 140 of the transfer unit 16 in any suitable manner, for example, via one or more quick connect fasteners, etc. In addition, the tools may include any desired tools capable of engaging and hold the trays, plates, containers, etc. herein.

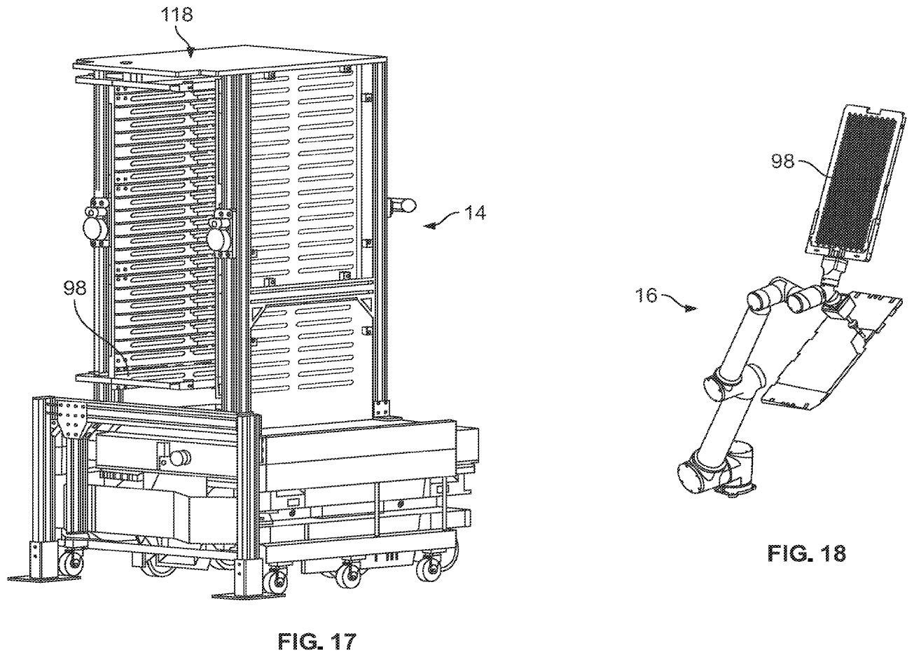

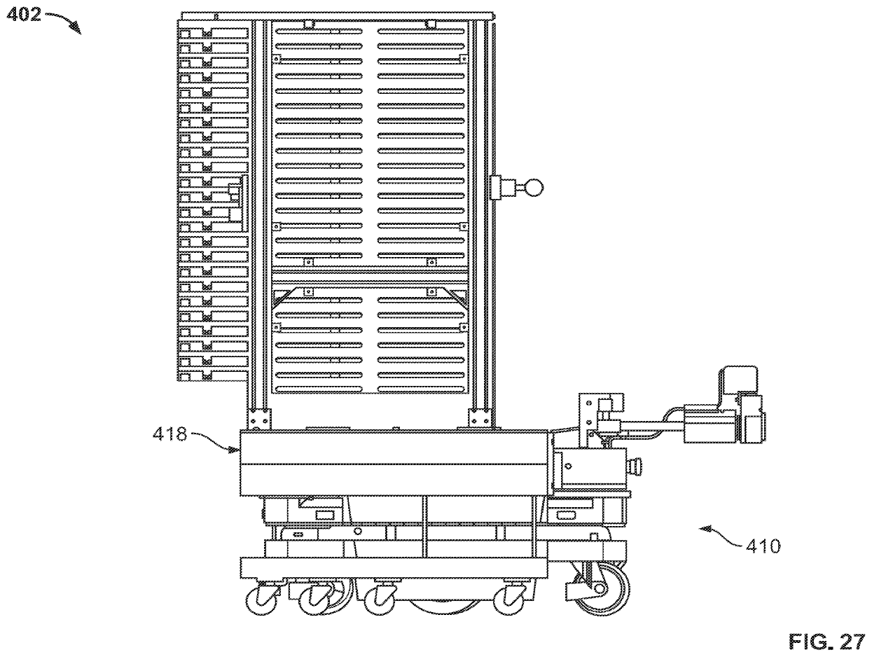

In connection with the above, a robot 410 (see also FIG. 17) is provided to position each of the docking stations 14, 402-408 relative to the sampling modules 12 and/or transfer unit 16 as needed. For instance, the robot 410 is configured to navigate across a floor or other surface (via wheels, an electric powered motor, etc.) and engage with (or within) the cart 418 of each of the docking stations 14, 402-408 (see, e.g., FIGS. 17 and 27). The robot 410 is then configured (e.g., via the control system 200, etc.) to navigate and direct the docking stations 402 as needed to a desired location for access by the transfer unit 16. That said, while the robot 410 is described for use in moving the docking stations 14, 402-408, it should be appreciated that in some embodiments the docking stations 14, 402-408 may be manually moved relative to the sampling modules 12 and/or transfer unit 16.

The illustrated robot 410 generally includes a wheeled base 464 and a platform 466 coupled to the wheeled base 464. As shown, the wheeled base 464 includes multiple wheels configured to move the robot 410, for example, across the floor. The platform 466 is coupled to the base 464 and is configured to engage/disengage the carts 418 of the different docking stations 14, 402-408. In this manner, when the platform 466 is engaged with the cart 418 of one of the docking stations 14, 402-408, the wheeled base 464 operates to drive the docking station to/from a desired location relative to the sampling modules 12 and/or transfer unit 16. This allows precise movement and docking of the robot 410, and helps ensure the transfer unit 16 (e.g., the robotic arm thereof, etc.) does not fault out, etc. when moving material to/from carts/docking stations. In addition, the robot 410 may include one or more sensors (e.g., cameras, infrared sensors, etc.) (broadly, guides 462) configured to detect a location of the robot 410 and/or a surrounding environment, etc. and thereby facilitate movement of the robot 410 to the desired position(s).

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having.” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent.” etc.). As used herein, the term “and/or” and the phrase “at least one of” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An automated system for sampling and/or sorting seeds, the system comprising:
a sampling module operable to remove tissue from a seed and deposit the seed from which the tissue is removed in a seed tray;
a docking station configured to hold the seed tray apart from the sampling module; and
a transfer unit configured to selectively transfer the seed tray between the sampling module and the docking station.

2. The automated system of claim 1, wherein the sampling module includes a seed plate configured to singulate the seed from multiple seeds.

3. The automated system of claim 2, wherein the seed plate includes multiple apertures each configured to hold a seed on the seed plate, and wherein at least one of the multiple apertures includes a different size than another one of the multiple apertures.

4. The automated system of claim 2, wherein the sampling module further includes:
a sampling assembly operable to remove the tissue from the seed; and
a transport unit operable to convey the singulated seed from the seed plate to the sampling assembly.

5. The automated system of claim 4, wherein the sampling module further includes an imaging assembly disposed between the seed plate and the sampling assembly, and wherein the imaging assembly is operable to collect one or more images of the singulated seed.

6. The automated system of claim 5, wherein the transport unit is operable to orient the singulated seed based on the collected one or more images.

7. The automated system of claim 1, wherein the sampling module further includes a sample collection assembly operable to collect the tissue removed from the seed.

8. The automated system of claim 7, wherein the sample collection assembly includes a platform configured to support a sample plate configured to receive the tissue removed from the seed, and wherein the sample collection assembly is operable to move the platform to a target location to receive the tissue removed from the seed.

9. The automated system of claim 8, wherein the sampling module further includes a seed collection assembly operable to support the seed tray in the sampling module.

10. The automated system of claim 9, wherein the sampling module further includes a seed deposit unit operable to deliver the seed from which the tissue is removed in the seed tray, the seed deposit unit coupled to the platform; and
wherein the sample collection assembly is operable to move the platform over the seed tray to thereby position the seed deposit unit to deliver the seed to the seed tray.

11. The automated system of claim 10, wherein the seed deposit unit is further operable to remove the seed from the seed tray.

12. The automated system of claim 1, wherein the sampling module is a first sampling module; and
wherein the automated system further comprises at least a second sampling module disposed generally above the first sampling module within a same footprint as the first sampling module.

13. The automated system of claim 1, wherein the docking station includes a cart configured to hold one or more of the seed tray on the cart, a sample plate on the cart, and an attachment for the transfer unit on the cart.

14. The automated system of claim 1, wherein the docking station is a first docking station;
wherein the automated system further includes at least a second docking station including a cart; and
wherein the cart of the first docking station is configured to hold one or more of the seed tray and a sample plate; and wherein the cart of the at least a second docking station is configured to hold an attachment for the transfer unit configured to hold the seed tray and/or the sample plate.

15. The automated system of claim 14, further comprising a robot configured to:
selectively engage the first docking station to position the first docking station relative to the transfer unit so that the transfer unit can selectively transfer the seed tray and/or the sample plate between the sampling module and the docking station; and
selectively engage the at least a second docking station to position the at least a second docking station relative to the transfer unit so that the transfer unit can selectively couple the attachment to an end portion of the transfer unit for use in transferring the seed tray and/or the sample plate between the sampling module and the docking station.

16. The automated system of claim 1, wherein the sampling module includes a robotic arm.

17. An automated seed sampling module for removing tissue from seeds, the automated seed sampling module comprising:
a seed plate configured to singulate a seed from multiple seeds, the seed plate including multiple apertures each configured to hold a seed on the seed plate, at least one of the multiple apertures including a different size than another one of the multiple apertures; and
a sampling assembly operable to remove tissue from the singulated seed.

18. The automated seed sampling module of claim 17, further comprising a transport unit operable to convey the singulated seed from the seed plate to the sampling assembly.

19. The automated seed sampling module of claim 17, further comprising an imaging assembly disposed between the seed plate and the sampling assembly, the imaging assembly operable to collect one or more images of the singulated seed.

20. An automated method for processing seeds, the method comprising:
singulating a seed from a plurality of seeds at a sampling module;
removing tissue from the singulated seed at the sampling module;
after removing tissue from the singulated seed, receiving the singulated seed in a well of a seed tray;
moving, by an automated transfer unit, the seed tray from the sampling module to a docking station;
returning, by the automated transfer unit, the seed tray from the docking station to the sampling module;
removing, by a seed deposit unit, the singulated seed from the well of the seed tray; and
delivering, by the seed deposit unit, the singulated seed to another well of the seed tray or to another seed tray.
